(19) United States
(12) Patent Application Publication
(10) Pub. No.: US 2024/0421286 A1
(43) Pub. Date: Dec. 19, 2024

(54) PROCESSES FOR PREPARING LITHIUM TRANSITION METAL PHOSPHATE CATHODE MATERIALS

(71) Applicant: Aspen Aerogels, Inc., Northborough, MA (US)

(72) Inventors: Hooman Yaghoobnejad Asl, Hudson, MA (US); Redouane Begag, Hudson, MA (US); Rushi Soni, Shrewsbury, MA (US); Nicholas Leventis, Worcester, MA (US)

(21) Appl. No.: 18/697,712

(22) PCT Filed: Mar. 30, 2023
(86) PCT No.: PCT/US2023/016845

§ 371 Date: Apr. 1, 2024

Related U.S. Application Data
(60) Provisional application No. 63/381,771, filed on Nov. 1, 2022.
(60) Provisional application No. 63/381,777, filed on Nov. 1, 2022.
(60) Provisional application No. 63/381,666, filed on Oct. 31, 2022.
(60) Provisional application No. 63/381,687, filed on Oct. 31, 2022.
(60) Provisional application No. 63/381,694, filed on Oct. 31, 2022.
(60) Provisional application No. 63/381,672, filed on Oct. 31, 2022.
(60) Provisional application No. 63/381,681, filed on Oct. 31, 2022.
(60) Provisional application No. 63/416,996, filed on Oct. 18, 2022.
(60) Provisional application No. 63/378,756, filed on Oct. 7, 2022.
(60) Provisional application No. 63/352,571, filed on Jun. 15, 2022.
(60) Provisional application No. 63/336,640, filed on Apr. 29, 2022.
(60) Provisional application No. 63/326,353, filed on Apr. 1, 2022.

(51) Int. Cl. H01M 4/36; H01M 4/02; H01M 4/136; H01M 4/58; H01M 4/62; H01M 10/0525

(52) U.S. Cl. CPC H01M 4/364; H01M 4/136; H01M 4/5825; H01M 4/625; H01M 10/0525; H01M 2004/021; H01M 2004/028

(57) ABSTRACT

The present disclosure is directed to methods of forming lithium transition metal phosphate and fluorophosphate materials in a conductive carbon matrix. The disclosed methods are advantageous in utilizing inexpensive reactants, can mitigate formation of impurities during the synthesis, providing a more homogenous product, and may provide cathode materials with enhanced tap density relative to prior lithium transition metal phosphates. The lithium transition metal phosphate and fluorophosphate materials prepared by the disclosed methods are intimately mixed with carbon within a continuous, three-dimensional conductive carbon matrix. The materials prepared according to the disclosed methods are suitable for use in environments involving electrochemical reactions, for example as cathode materials within a lithium-ion battery.

### CROSS REFERENCES TO RELATED APPLICATIONS

This application claims priority to and the benefit of U.S. Provisional Patent Application No. 63/381,777, filed Nov. 1, 2022, U.S. Provisional Patent Application No. 63/381,771, filed Nov. 1, 2022, U.S. Provisional Patent Application No. 63/381,694, filed Oct. 31, 2022, U.S. Provisional Patent Application No. 63/381,687, filed Oct. 31, 2022, U.S. Provisional Patent Application No. 63/381,681, filed Oct. 31, 2022, U.S. Provisional Patent Application No. 63/381,672, filed Oct. 31, 2022, U.S. Provisional Patent Application No. 63/381,666, filed Oct. 31, 2022, U.S. Provisional Patent Application No. 63/416,996, filed Oct. 18, 2022, U.S. Provisional Patent Application No. 63/378,756, filed Oct. 7, 2022, U.S. Provisional Patent Application No. 63/352,571, filed Jun. 15, 2022, U.S. Provisional Patent Application No. 63/336,640, filed Apr. 29, 2022, and U.S. Provisional Patent Application No. 63/326,353, filed Apr. 1, 2022, each of which is herein incorporated by reference in its entirety.

### TECHNICAL FIELD

The present disclosure relates generally to cathode active materials for use in lithium-ion batteries and to processes for making the same.

### BACKGROUND

One of the most common forms of rechargeable battery is the lithium-ion battery (LIB). LIBs have seen widespread use in a variety of applications, from handheld electronics to automobiles. LIBs are a type of battery in which lithium ions travel from an anode to a cathode during discharge and from the cathode to the anode during the charge cycle (recharging). Conventionally, the anode of LIBs is formed of graphite and/or alloying materials (e.g., Si), or oxides (e.g., Li₄Ti₅O₁₂) where lithium ions intercalate within graphite layers during the charge cycle, providing energy storage. LIB cathode materials are commonly oxide compounds of nickel, cobalt, or manganese (“NCM”) or aluminum. NCM cathode materials are interesting because these materials have a high charge capacity (˜200 milliAmp hours/gram (mAh/g)) relative to other types of cathode materials. However, these materials can be expensive to prepare and may adversely affect the environment by virtue of the need to obtain and process expensive ores to provide the necessary precursors, during which toxic waste materials are produced.

Another LIB cathode material is lithium iron phosphate (e.g., LiFePO₄; “LFP”). Such LFP cathode materials have a lower theoretical charge capacity (˜170 mAh/g) than NCM cathode materials. Nevertheless, LFPs have a number of commercial advantages including, but not limited to, reduced environmental impact and, relative to the ores for preparing NCMs, inexpensive precursors. However, LFPs have synthetic drawbacks that offset some of these advantages. For example, most previously reported synthetic processes involve extensive mechanical mixing (e.g., via ball milling) of solid-phase precursor materials to achieve the intimate contact between precursors necessary to provide a homogenous product.

Accordingly, it would be desirable in the art to provide methods for preparing lithium transition metal phosphate cathode active materials which are efficient, relatively inexpensive, and have low environmental impact.

### SUMMARY

The present technology is generally directed to a method for preparing lithium transition metal phosphate cathode materials within a conductive carbon matrix.

Various solid and solution phase methods of forming lithium iron phosphate (LFP) materials have been previously reported. See, for example, U.S. Patent Application Publication Nos. 2011/0110838 to Wang et al., 2008/0099720 to Huang et al., 2010/0065787, and 2011/0091772 to Mishima et al.; U.S. Pat. No. 7,988,879 to Park et al. and U.S. Pat. No. 7,060,238 to Saidi et al.; European Patent Application Publication No. 1,921,698 to Dong; and International Patent Application Publication No. WO2004/092065 to Barker et al.

The method disclosed herein, in at least some aspects, possesses advantages relative to previously reported methods of preparing LFP materials, including LFPs within a conductive carbon matrix. While previously reported methods provide, e.g., LFP cathode materials comprising carbon, this carbon is typically added using either carbon particles (e.g., carbon black) or pyrolysis of a mixture of LFP precursors and sugar molecules. Neither of these prior methods of introducing carbon to the cathode material provide a conductive matrix comparable to that provided according to the disclosed method.

The benefits of some or all of the aspects described herein include removing various process steps of LFP synthesis relative to more conventional methods by which LFP cathode materials are synthesized. For example, many conventional LFP processes use solution chemistry techniques that may generate quantities of wastewater (e.g., aqueous ammonia solutions). The generation of wastewater is nearly completely avoided in some of the aspects of the present disclosure. Furthermore, conventional solid phase reactions that produce LFP (and largely avoid wastewater generation) have the disadvantage of requiring significant energy inputs for mixing and milling large quantities of dense, solid-phase powders. The product of powder mixing is also less likely to be homogenous and uniform LFP due to the difficulty of achieving and maintain a compositionally uniform mixture of the precursors. Because aspects of the present disclosure maintain intimate contact of the reactants in the viscous media, the extent and duration of mixing and milling is reduced relative to conventional techniques. This reduces the energy needed to synthesize LFP and the complexity of the process. A further advantage is that the present method only requires pyrolysis under an inert (e.g., nitrogen) atmosphere. In contrast, certain prior methods require a reducing (hydrogen) atmosphere, adding to the complexity, cost, and hazard of performing such syntheses. The disclosed method surprisingly allows control of the carbon content in the lithium transition metal phosphate cathode materials within a conductive carbon matrix, down to a range on the order of 1-10% by weight, provide a LFP active material utilization in the range of 85-90% (suitable for commercial products), and is scalable and inexpensive. Further, in some aspects, the method disclosed herein provides a lithium transition metal phosphate with enhanced tap density relative to prior lithium transition metal phosphates, thereby improving the commercial viability of such materials in battery packs. The disclosed method, and materials prepared by the method, possesses additional advantages which are further described herein below.

The method disclosed herein generally comprises combining a group of precursors for synthesizing the lithium transition metal phosphate cathode material, providing one or more carbon precursors in a fluid state, mixing the group of precursors with the one or more carbon precursors to form a precursor mixture; adding the gelation initiator to the precursor mixture; allowing the one or more carbon precursor to undergo gelation to form a solid organogel; and pyrolyzing the solid organogel to form the lithium transition metal phosphate cathode material within the conductive carbon matrix. The one or more carbon precursors are configured to form a solid organogel in the presence of a gelation initiator, and the solid organogel is configured to form a conductive carbon matrix upon pyrolysis. It is to be understood that the solid organogel produced in the disclosed method is formed by gelation of the carbon precursors, and pyrolysis of the organogel produces the conductive carbon matrix. It is also to be understood that throughout the disclosure, in the context of the described method, the terms “solid organogel” and “organogel” are intended to be interpreted as further comprising the precursors for synthesizing the lithium transition metal phosphate cathode material and/or intermediate reaction products of these various precursors, unless the context makes it clear that solely the organogel is being described. In the disclosed method, at least a first precursor of the group of precursors for synthesizing the lithium transition metal phosphate cathode material comprises a solid phase having a first density greater than 1 gram (g)/cubic centimeter (cc), and at least a second precursor of the group comprises a liquid phase having a second density, wherein the second density is less than the first density. The solid organogel prevents solid phase components in the group of precursors from separating (e.g., settling by virtue of the density gradient between the solid and liquid phases) from the liquid phase components in the group of precursors. Particularly, the solid organogel maintains uniform contact of the lithium transition metal phosphate group of precursors within the mixture so that the precursors may react to form the lithium transition metal phosphate cathode material (e.g., a lithium iron phosphate (LFP)). Furthermore, the solid organogel may also contribute to the synthesis of commercially viable LFPs by being converted into a conductive carbon matrix needed for using LFPs as cathode materials.

As described above, the method disclosed herein is advantageous in maintaining uniform contact between the various precursor materials, for example, an Fe precursor and a lithium phosphate. Significantly, because the solid organogel materials utilized in the methods are selected to maintain the solid state to fairly high temperatures (e.g., up to at least about 300° C.), the solid organogel continues to maintain the contact between the transition metal (e.g., Fe) precursor and the intermediate lithium phosphate (LiH₂PO₄) beyond the melting temperature of LiH₂PO₄. This enables the precursors to react into LFP, and not phase separate, even when the LiH₂PO₄ has melted into a liquid phase at the LFP synthesis reaction temperature. Because the organogel precursors and conditions are selected to allow rapid gelation (e.g., under 15 minutes, such as from a few seconds to about 15 minutes), the benefits of the solid organogel with respect to maintaining contact between precursors is realized rapidly. Further, in some aspects, the method provides for more intimate mixing and interaction of the precursor material on a smaller scale (e.g., nano-sized, solvated molecule scale) as compared to methods which mix the components as solid phase (e.g., micron-sized) particles. This more intimate mixing can mitigate formation of impurities during the synthesis and provides a more homogenous product. Surprisingly, such intimate mixing can be accomplished with a reduction of or even elimination of the intensive milling required in prior reported processes. Another benefit of the disclosed method is that the gelation of the organogel precursors in the presence of the lithium transition metal phosphate precursors allows, after pyrolysis, production of cathode materials that are intimately mixed with carbon within a continuous, three-dimensional conductive carbon matrix.

Accordingly, in one aspect is provided a method of preparing a lithium transition metal phosphate cathode material within a conductive carbon matrix, the method comprising:
combining a group of precursors for synthesizing the lithium transition metal phosphate cathode material, wherein at least a first precursor of the group comprises a solid phase having a first density greater than 1 gram (g)/cubic centimeter (cc), and at least a second precursor of the group comprises a liquid phase having a second density, wherein the second density is less than the first density;
providing one or more carbon precursors in a fluid state, the one or more carbon precursors configured to form a solid organogel in the presence of a gelation initiator, the solid organogel configured to form a conductive carbon matrix upon pyrolysis;
mixing the group of precursors with the one or more carbon precursors to form a precursor mixture;
adding the gelation initiator to the precursor mixture;
allowing the one or more carbon precursor to undergo gelation to form a solid organogel; and
pyrolyzing the solid organogel to form the lithium transition metal phosphate cathode material within the conductive carbon matrix.

In some aspects, the solid organogel forms within 5 seconds to 15 minutes after addition of the gelation initiator.

In some aspects, the solid organogel comprises a porous network of interconnected solid phase polymer structures.

In some aspects, the porous network maintains contact between the first precursor of the group and the second precursor of the group.

In some aspects, the contact is maintained to a temperature of at least about 300° C.

In some aspects, the first precursor comprises iron; the second precursor comprises a lithium source and phosphoric acid; and the lithium transition metal phosphate cathode material is lithium iron phosphate.

In some aspects, the iron is present in the form of an iron (II) salt, an iron (III) salt, iron (II) oxide (FeO), iron (III) oxide (Fe₂O₃), a mixed iron oxide (Fe₃O₄), or a combination thereof.

In some aspects, the solid organogel comprises a phloroglucinol-furfural polymer or a resorcinol-furfural polymer, and the one or more carbon precursors are phloroglucinol or resorcinol and furfural. In some aspects, the gelation initiator is an amine base or an acid.

In some aspects, the solid organogel comprises a polyurethane polymer, and the one or more carbon precursors comprise a polyol and an isocyanate. In some aspects, the gelation initiator comprises an alkylamine.

In some aspects, the organogel comprises a polyamic acid polymer and the gelation initiator comprises acetic anhydride, acetic acid, or a combination thereof.

In some aspects, the group of precursors includes a precursor having microwave susceptibility and the pyrolyzing is performed by applying microwave radiation. In some aspects, the precursor having microwave susceptibility comprises one or more of carbon, magnetite, and maghemite. In some aspects, the precursor having microwave susceptibility comprises nanoparticles of one or more of magnetite and maghemite having a characteristic dimension of from 20 nm to 100 nm.

In some aspects: the first precursor comprises manganese, vanadium, or both; the second precursor comprises a lithium source and phosphoric acid; and the lithium transition metal phosphate cathode material is lithium manganese phosphate or lithium vanadium phosphate.

In some aspects, the method further comprises drying the lithium transition metal phosphate cathode material by applying microwave radiation.

In some aspects, the solid phase having the first density greater than 1 gram comprises a ferromagnetic iron compound, a ferrimagnetic iron compound, or both.

In some aspects, the ferromagnetic iron compound, the ferrimagnetic iron compound, or both are synthesized by a method comprising oxidizing an iron-containing anode in an electrochemical cell with a porous carbon substrate, an oxygen cathode, and an electrolyte in contact with both the iron-containing anode and the porous carbon substrate, wherein the oxidizing produces particles of the ferromagnetic iron compound, the ferrimagnetic iron compound, or both, having a characteristic dimension of from 20 nm to 100 nm.

In some aspects, the method further comprises removing the particles by magnetic filtration.

In some aspects, the method further comprises drying the particles by applying microwave radiation.

In some aspects, operation of the electrochemical cell and formation of the ferromagnetic iron compound, the ferrimagnetic iron compound, or both is at a temperature between 15° C. and 35° C.

In another aspect is provided a lithium transition metal phosphate cathode material prepared by the method disclosed herein.

In yet another aspect is provided an energy storage system comprising a lithium transition metal phosphate cathode material prepared by the method disclosed herein.

In a yet further aspect is provided a composition comprising a nanoparticle comprising olivine lithium iron phosphate and integral with a conductive carbon matrix, wherein the nanoparticle has a characteristic dimension from 20 nm to 1000 nm, and a specific surface area from 10 meters² (m²)/gram (g) to 65 m²/g. In some aspects, the characteristic dimension is from 30 nm to 70 nm and the specific surface area is from 20 m²/g to 65 m²/g. In some aspects, the characteristic dimension is from 30 nm to 60 nm and the specific surface area is from 22 m²/g to 40 m²/g. In some aspects, the characteristic dimension is from 20 nm to 40 nm and the specific surface area is from 60 m²/g to 80 m²/g.

In some aspects, the nanoparticle further comprises magnetite, maghemite, or both.

In some aspects, the nanoparticle further comprises manganese.

In some aspects, the conductive carbon matrix comprises a carbonized organogel polymer matrix.

In yet another aspect is provided an energy storage system comprising the composition of as disclosed herein.

The disclosure includes, without limitations, the following aspects.

Aspect 1: A method of preparing a lithium transition metal phosphate cathode material within a conductive carbon matrix, the method comprising:
combining a group of precursors for synthesizing the lithium transition metal phosphate cathode material, wherein at least a first precursor of the group comprises a solid phase having a first density greater than 1 gram (g)/cubic centimeter (cc), and at least a second precursor of the group comprises a liquid phase having a second density, wherein the second density is less than the first density;
providing one or more carbon precursors in a fluid state, the one or more carbon precursors configured to form a solid organogel in the presence of a gelation initiator, the solid organogel configured to form a conductive carbon matrix upon pyrolysis;
mixing the group of precursors with the one or more carbon precursors to form a precursor mixture;
adding the gelation initiator to the precursor mixture;
allowing the one or more carbon precursor to undergo gelation to form a solid organogel; and
pyrolyzing the solid organogel to form the lithium transition metal phosphate cathode material within the conductive carbon matrix.

Aspect 2: The method of Aspect 1, wherein the solid organogel forms within 5 seconds to 15 minutes after addition of the gelation initiator.

Aspect 3: The method of Aspect 1 or 2, wherein the solid organogel comprises a porous network of interconnected solid phase polymer structures.

Aspect 4: The method of any one of Aspects 1-3, wherein the porous network maintains contact between the first precursor of the group and the second precursor of the group.

Aspect 5: The method of any one of Aspects 1-4, wherein the contact is maintained to a temperature of at least about 300° C.

Aspect 6: The method of any one of Aspects 1-5, wherein the first precursor comprises iron; the second precursor comprises a lithium source and phosphoric acid; and the lithium transition metal phosphate cathode material is lithium iron phosphate.

Aspect 7: The method of any one of Aspects 1-6, wherein the first precursor comprises iron; the second precursor comprises a lithium source and phosphoric acid; and the lithium transition metal phosphate cathode material is lithium iron phosphate.

Aspect 8: The method of any one of Aspects 1-7, wherein the iron is present in the form of an iron (II) salt, an iron (III) salt, iron (II) oxide (FeO), iron (III) oxide (Fe₂O₃), a mixed iron oxide (Fe₃O₄), or a combination thereof.

Aspect 9: The method of any one of Aspects 1-8, wherein the solid organogel comprises a phloroglucinol-furfural polymer or a resorcinol-furfural polymer, and the one or more carbon precursors are phloroglucinol or resorcinol and furfural.

Aspect 10: The method of Aspect 9, wherein the gelation initiator is an amine base or an acid.

Aspect 11: The method of any one of Aspects 1-8, wherein the solid organogel comprises a polyurethane polymer, and the one or more carbon precursors comprise a polyol and an isocyanate.

Aspect 12: The method of Aspect 11, wherein the gelation initiator comprises an alkylamine.

Aspect 13: The method of any one of Aspects 1-8, wherein the organogel comprises a polyamic acid polymer and the gelation initiator comprises acetic anhydride, acetic acid, or a combination thereof.

Aspect 14: The method of any one of Aspects 1-13, wherein the group of precursors includes a precursor having microwave susceptibility and the pyrolyzing is performed by applying microwave radiation.

Aspect 15: The method of Aspect 14, wherein the precursor having microwave susceptibility comprises one or more of carbon, magnetite, and maghemite.

Aspect 16: The method of Aspect 14, wherein the precursor having microwave susceptibility comprises nanoparticles of one or more of magnetite and maghemite having a characteristic dimension of from 20 nm to 100 nm.

Aspect 17: The method of any one of the preceding Aspects, wherein the first precursor comprises manganese, vanadium, or both; the second precursor comprises a lithium source and phosphoric acid; and the lithium transition metal phosphate cathode material is lithium manganese phosphate or lithium vanadium phosphate.

Aspect 18: The method of any one of preceding Aspects, wherein the method further comprises drying the lithium transition metal phosphate cathode material by applying microwave radiation.

Aspect 19: The method of any one of preceding Aspects, wherein the solid phase having the first density greater than 1 gram comprises a ferromagnetic iron compound, a ferrimagnetic iron compound, or both.

Aspect 20: The method of any one of preceding Aspects, wherein the ferromagnetic iron compound, the ferrimagnetic iron compound, or both are synthesized by a method comprising oxidizing an iron-containing anode in an electrochemical cell with a porous carbon substrate, an oxygen cathode, and an electrolyte in contact with both the iron-containing anode and the porous carbon substrate, wherein the oxidizing produces particles of the ferromagnetic iron compound, the ferrimagnetic iron compound, or both, having a characteristic dimension of from 20 nm to 100 nm.

Aspect 21: The method of Aspect 20, wherein the method further comprises removing the particles by magnetic filtration.

Aspect 22: The method of any one of preceding Aspects, wherein the method further comprises drying the particles by applying microwave radiation.

Aspect 23: The method of Aspect 20, wherein operation of the electrochemical cell and formation of the ferromagnetic iron compound, the ferrimagnetic iron compound, or both is at a temperature between 15° C. and 35° C.

Aspect 24: A lithium transition metal phosphate cathode material prepared by the method disclosed herein.

Aspect 25: An energy storage system comprising a lithium transition metal phosphate cathode material prepared by the method disclosed herein.

Aspect 26: A composition comprising a nanoparticle comprising olivine lithium iron phosphate and integral with a conductive carbon matrix, wherein the nanoparticle has a characteristic dimension from 20 nm to 1000 nm, and a specific surface area from 10 meters² (m²)/gram (g) to 65 m²/g.

Aspect 27: The composition of Aspect 26, wherein the characteristic dimension is from 30 nm to 70 nm and the specific surface area is from 20 m²/g to 65 m²/g.

Aspect 28: The composition of Aspect 26, wherein the characteristic dimension is from 30 nm to 60 nm and the specific surface area is from 22 m²/g to 40 m²/g.

Aspect 29: The composition of Aspect 26, wherein the characteristic dimension is from 20 nm to 40 nm and the specific surface area is from 60 m²/g to 80 m²/g.

Aspect 30: The composition of any one of Aspects 26-29, wherein the nanoparticle further comprises magnetite, maghemite, or both.

Aspect 31: The composition of any one of Aspects 26-30, wherein the nanoparticle further comprises manganese.

Aspect 32: The composition of any one of Aspects 26-31, wherein the conductive carbon matrix comprises a carbonized organogel polymer matrix.

Aspect 33: An energy storage system comprising the composition of as disclosed herein.

These and other features, aspects, and advantages of the disclosure will be apparent from a reading of the following detailed description together with the accompanying drawings, which are briefly described below. The invention includes any combination of two, three, four, or more of the above-noted aspects as well as combinations of any two, three, four, or more features or elements set forth in this disclosure, regardless of whether such features or elements are expressly combined in a specific aspect description herein. This disclosure is intended to be read holistically such that any separable features or elements of the disclosed invention, in any of its various aspects, should be viewed as intended to be combinable unless the context clearly dictates otherwise.

### BRIEF DESCRIPTION OF THE DRAWINGS

In order to provide an understanding of aspects of the technology, reference is made to the appended drawings, which are not necessarily drawn to scale. The drawings are exemplary only and should not be construed as limiting the technology. The disclosure described herein is illustrated by way of example and not by way of limitation in the accompanying drawings.

FIG. 1 is a schematic depiction of a conventional solid-state synthesis route to lithium iron phosphate in a carbon matrix.

FIG. 2 is a schematic depiction of a slurry/sol-gel synthesis route to lithium iron phosphate in a carbon matrix according to a non-limiting aspect of the disclosure.

FIG. 3 schematically illustrates a system for oxidizing transition metals, including but not limited to iron, using a carbon aerogel component, in accordance with a non-limiting aspect.

FIG. 4 schematically illustrates an electrochemical cell for oxidizing transition metals, including but not limited to iron, using a carbon aerogel component, in accordance with a non-limiting aspect.

FIG. 5A is a scanning electron micrograph at a magnification of 100,000× of a sample of nanoparticulate magnetite (Fe₃O₄) prepared by forced acro-anodization of iron according to a non-limiting aspect of the disclosure.

FIG. 5B is a powder X-ray diffraction (XRD) pattern of a sample of nanoparticulate magnetite prepared by forced aero-anodization of iron according to a non-limiting aspect of the disclosure.

FIG. 6 is a schematic depiction of a semi-continuous method of preparing nanoparticulate magnetite from forced aero-anodization of iron and converting it to a lithium iron phosphate in a carbon matrix according to a non-limiting aspect of the disclosure.

FIGS. 7A and 7B are scanning electron micrographs at two magnifications (1,490× and 5,050×, respectively) of a sample of lithium iron phosphate in a carbon matrix prepared according to a non-limiting aspect of the disclosure.

FIG. 8 is a powder X-ray diffraction (XRD) pattern for a sample of lithium iron phosphate in a carbon matrix prepared according to a non-limiting aspect of the disclosure.

FIGS. 9A and 9B are scanning electron micrographs at two magnifications (10,000× and 49,900×, respectively) of a sample of lithium iron phosphate in a carbon matrix prepared according to a non-limiting aspect of the disclosure.

FIG. 10 is a powder XRD pattern for a sample of lithium iron phosphate in a carbon matrix prepared according to a non-limiting aspect of the disclosure.

FIGS. 11A and 11B are scanning electron micrographs at two magnifications (10,000× and 100,000×, respectively) of a sample of lithium iron phosphate in a carbon matrix prepared according to a non-limiting aspect of the disclosure.

FIG. 12 is a powder XRD pattern for a sample of lithium iron phosphate in a carbon matrix prepared according to a non-limiting aspect of the disclosure.

FIGS. 13A and 13B are scanning electron micrographs at two magnifications (2,000× and 20,000×, respectively) of a sample of lithium iron phosphate in a carbon matrix prepared according to a non-limiting aspect of the disclosure.

FIG. 14 is a powder XRD pattern for a sample of lithium iron phosphate in a carbon matrix prepared according to a non-limiting aspect of the disclosure.

FIGS. 15A and 15B are scanning electron micrographs at two magnifications (2,000× and 50,000×, respectively) of a sample of lithium iron phosphate in a carbon matrix prepared according to a non-limiting aspect of the disclosure.

FIG. 16 is a powder XRD pattern for a sample of lithium iron phosphate in a carbon matrix prepared according to a non-limiting aspect of the disclosure.

FIG. 17 is a powder XRD pattern for a sample of lithium iron phosphate in a carbon matrix prepared according to a non-limiting aspect of the disclosure.

### DETAILED DESCRIPTION

Before describing several example aspects of the technology, it is to be understood that the technology is not limited to the details of construction or process steps set forth in the following description. The technology is capable of other aspects and of being practiced or being carried out in various ways.

In general, the technology is directed to methods for preparing lithium transition metal phosphate cathode materials within a conductive carbon matrix. According to the present disclosure, it was surprisingly found that lithium transition metal phosphate cathode materials prepared as disclosed herein provides a more homogenous product without requiring intensive milling steps and also provides cathode materials with enhanced tap density relative to prior methods for preparing lithium transition metal phosphates. Further, the disclosed methods provide lithium transition metal phosphate cathode materials that are intimately mixed with carbon within a continuous, three-dimensional conductive carbon matrix.

Accordingly, provided herein is a method of preparing lithium iron phosphate, lithium-transition metal-phosphate, and lithium vanadium fluorophosphate cathode materials within a conductive carbon matrix. As a general, non-limiting description, the disclosed method generally comprises combining a group of precursors for synthesizing the lithium transition metal phosphate cathode material, providing one or more carbon precursors in a fluid state, mixing the group of precursors with the one or more carbon precursors to form a precursor mixture; adding the gelation initiator to the precursor mixture; allowing the one or more carbon precursor to undergo gelation to form a solid organogel; and pyrolyzing the solid organogel to form the lithium transition metal phosphate cathode material within the conductive carbon matrix. Further provided is a lithium transition metal phosphate cathode material prepared by the disclosed method, a composition comprising a nanoparticle comprising olivine lithium iron phosphate and integral with a conductive carbon matrix, and energy storage systems comprising the lithium transition metal phosphate cathode materials or compositions as described herein. Each of the components of the method, the materials, and products comprising the materials are described further herein below.

### Definitions

With respect to the terms used in this disclosure, the following definitions are provided. This application will use the following terms as defined below unless the context of the text in which the term appears requires a different meaning.

The articles “a” and “an” are used herein to refer to one or to more than one (i.e., to at least one) of the grammatical object of the article.

The term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Any ranges cited herein are inclusive.

As used herein, the terms “comprises” and “comprising” and variations thereof mean that the specified features, steps or integers are included. The terms are not to be interpreted to exclude the presence of other features, steps or components. The invention comprises, consists of or consists essentially of the disclosed and claimed features.

Within the context of the present disclosure, the terms “framework” or “framework structure” refer to the network of interconnected oligomers, polymers, or colloidal particles that form the solid structure of a gel or a xerogel. The polymers or particles (e.g., carbon) that make up the framework structures typically have a diameter of about 100 Angstroms. However, framework structures of the present disclosure can also include networks of interconnected oligomers, polymers, or colloidal particles of all diameter sizes that form the solid structure within in a gel or xerogel.

In some aspects, a gel material may be referred to herein specifically as a xerogel. As used herein, the term “xerogel” refers to a type of gel comprising an open, non-fluid colloidal or polymer networks that is formed by the removal of all swelling agents from a corresponding wet gel without any precautions taken to avoid substantial volume reduction or to retard compaction. A xerogel generally comprises a compact structure. Xerogels suffer substantial volume reduction during ambient pressure drying, and generally have surface areas of 0-100 m²/g, such as from about 0 to about 20 m²/g as measured by nitrogen sorption analysis.

As used herein, the term “gelation” or “gel transition” refers to the formation of a wet gel from a polymer system, e.g., a PF or polyimide as described herein. At a point in the polymerization, imidization or drying as described herein, defined as the “gel point,” the sol loses fluidity. Without intending to be bound to any particular theory, the gel point may be viewed as the point where the gelling solution exhibits resistance to flow. In the present context, gelation proceeds from an initial sol state (e.g., a liquid solution of an ammonium salt of a polyamic acid), through a highly viscous disperse state, until the disperse state solidifies and the sol gels (the gel point), yielding a wet gel (e.g., a polyimide gel). The amount of time it takes for the polymer in solution to transform into a gel in a form that can no longer flow is referred to as the “phenomenological gelation time.” Formally, gelation time is measured using rheology. At the gel point, the clastic property of the solid gel starts dominating over the viscous properties of the fluid sol. The formal gelation time is near the time at which the real and imaginary components of the complex modulus of the gelling sol cross. The two moduli are monitored as a function of time using a rheometer. Time starts counting from the moment the last component of the sol is added to the solution. See, for example, discussions of gelation in H. H. Winter “Can the Gel Point of a Cross-linking Polymer Be Detected by the G′-G′ Crossover?” Polym. Eng. Sci., 1987, 27, 1698-1702; S.-Y. Kim, D.-G. Choi and S.-M. Yang “Rheological analysis of the gelation behavior of tetraethylorthosilane/vinyltriethoxysilane hybrid solutions” Korean J. Chem. Eng., 2002, 19, 190-196; and M. Muthukumar “Screening effect on viscoelasticity near the gel point” Macromolecules, 1989, 22, 4656-4658. In some aspects, gelation is induced by addition of a suitable gelation initiator. In other aspects, gelation may be induced by removal of solvent, e.g., from a solution comprising a salt of a polyamic acid. Such solvent removal can be accomplished by various drying techniques including, but not limited to, spray drying.

As used herein, the term “wet gel” refers to a gel in which the mobile interstitial phase within the network of interconnected pores is primarily comprised of a liquid phase such as a conventional solvent or water. Examples of wet-gels include, but are not limited to: alcogels, hydrogels, ketogels, carbonogels, and any other wet-gels known to those in the art.

The term “carbon xerogel” as used herein refers to porous, carbon-based material. Some non-limiting examples of carbon xerogels include carbonized xerogels such as carbonized polyimide gels. The term “carbonized” in the context of xerogels refers to an organic gel (e.g., a PF polymer or polyimide) which has been subjected to pyrolysis in order to decompose or transform the organogel composition to at least substantially pure carbon. As used herein, the terms “pyrolyze” or “pyrolysis” or “carbonization” refer to the decomposition or transformation of an organic matrix to pure or substantially pure carbon caused by heat. As describe herein below, during such pyrolysis, reaction of the various components present in the matrix occurs, simultaneously or subsequently forming the respective lithium transition metal phosphate or fluorophosphate cathode material within the carbon matrix.

As used herein, the term “average particle size” is synonymous with D₅₀, meaning half of the population of particles has a particle size above this point, and half below. Particle size may be measured by laser light scattering techniques or by microscopic techniques. Unless otherwise indicated, average particle sizes reported herein are obtained by visual interpretation of SEM images using the calibration scale bar and image processing software (such as ImageJ). Multiple particles are measured randomly, the results are averaged, and standard deviations are calculated. For secondary particles and aggregates, laser diffraction particle size analysis is used.

Within the context of the present disclosure, the term “density” refers to a measurement of the mass per unit volume of a material. The term “density” generally refers to the true or skeletal density of a material, the bulk density of a material or composition, or the tap density of a material or composition. Density is typically reported as kg/m³ or g/cm³.

The skeletal density of a material is the ratio of the mass of the material to the volume of the material, excluding any pores in the material and any void spaces between particles of the material. Skeletal density may be determined by methods known in the art, including, but not limited to, helium pycnometry.

The bulk density of a material is the ratio of the mass of the material to the volume of the material including any pores in the material and any void spaces between particles of the material. Also referred to as “envelope density,” the bulk density may be determined by methods known in the art, including, but not limited to: Standard Test Method for Dimensions and Density of Preformed Block and Board-Type Thermal Insulation (ASTM C303, ASTM International, West Conshohocken, Pa.); Standard Test Methods for Thickness and Density of Blanket or Batt Thermal Insulations (ASTM C167, ASTM International, West Conshohocken, Pa.); or Determination of the apparent density of preformed pipe insulation (ISO 18098, International Organization for Standardization, Switzerland). Within the context of the present disclosure, density measurements are acquired according to ASTM C167 standards, unless otherwise stated.

Within the context of the present disclosure, the term “tap density” or “tapped density” of a material is the ratio of the mass of the material to the volume of the material measured when the material is vibrated or tapped under specific conditions. The tapped density of a powder represents its random dense packing. Tapped density values are higher for more regularly shaped particles (e.g., spheres) as compared to irregularly shaped particles. Tapped density can be calculated using the formula M/V_{f}, where M=mass in grams, and Vᵢ=the tapped volume in cubic centimeters (cm³). Tapped density is generally measured by first gently introducing a known sample mass into a graduated cylinder and carefully leveling the powder without compacting it. The cylinder is then mechanically tapped by raising the cylinder and allowing it to drop under its own weight using a suitable mechanical tapped density tester that provides a suitable fixed drop distance and nominal drop rate. Standard test methods for tap density measurements are described in MPIF-46, ASTM B-52722, and ISO 3953. Unless otherwise indicated, tap density of a material described herein is obtained in accordance with the method of ASTM B-52722.

As used herein, the term “positive electrode” is used interchangeably with cathode. Likewise, the term “negative electrode” is used interchangeably with anode.

Within the context of the present disclosure, the term “electrical conductivity” refers to a measurement of the ability of a material to conduct an electric current or other allow the flow of electrons therethrough or therein. Electrical conductivity is specifically measured as the electric conductance/susceptance/admittance of a material per unit size of the material. It is typically recorded as S/m (Siemens/meter) or S/cm (Siemens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84-resistivity (R) measurements obtained by measuring voltage (V) divided by current (I), unless otherwise stated. In certain aspects, materials of the present disclosure have an electrical conductivity of about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

The term “substantially” as used herein, unless otherwise indicated, means to a great extent, for example, greater than about 95%, greater than about 99%, greater than about 99.9%, greater than 99.99%, or even 100% of a referenced characteristic, quantity, etc. as pertains to the particular context (e.g., substantially pure, substantially the same, and the like).

### I. Method of Preparing Lithium Transition Metal Phosphate Cathode Materials Within a Conductive Carbon Matrix

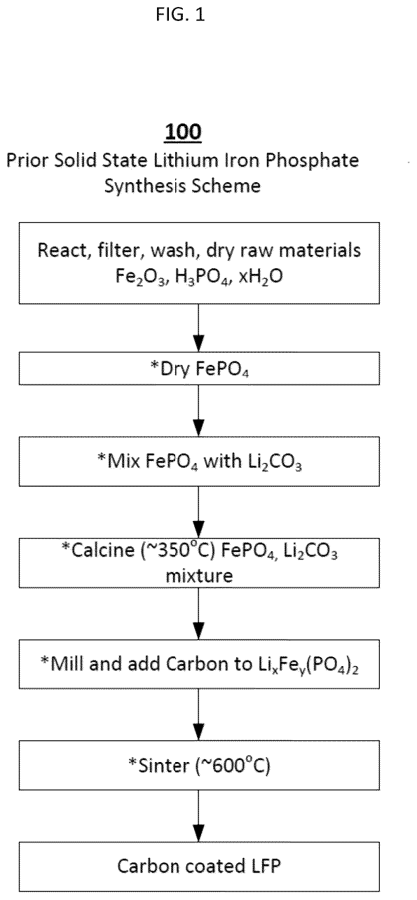

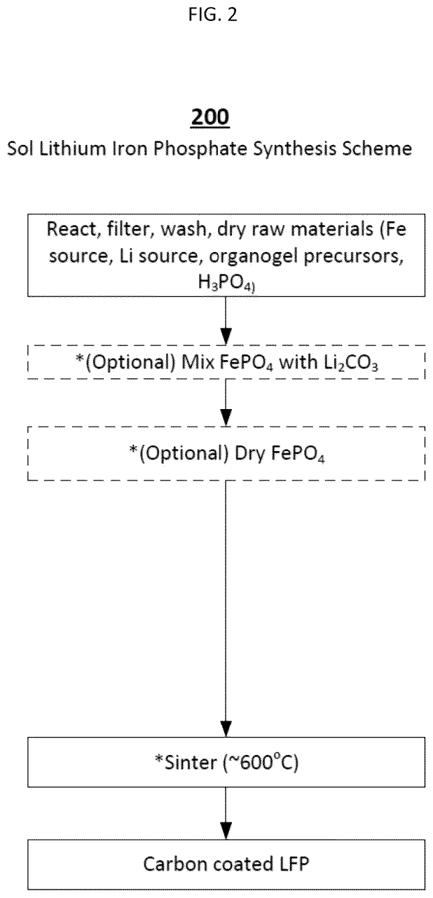

In one aspect is provided a method of preparing a lithium transition metal phosphate cathode material within a conductive carbon matrix. As described herein above, many previously reported synthetic processes for preparation of lithium transition metal phosphate cathode materials such as lithium iron phosphates (LFPs) involve extensive mechanical mixing (e.g., via ball milling) of solid-phase precursor materials to achieve the intimate contact between precursors necessary to provide a homogenous product. Further, such solid-phase schemes utilize multiple energy-intensive steps. For example, FIG. 1 provides a schematic illustration of a typical solid-phase process method 100. With reference to FIG. 1, drying, mixing, milling, calcination, and sintering all require significant energy input, time, or both, increasing production costs. Energy intensive steps are indicated by an asterisk. In contrast, the methods disclosed herein are advantageous at least with respect to reducing the number of energy and/or time intensive steps. For example, FIG. 2 provides a schematic illustration of a process 200 according to a non-limiting aspect using the slurry/sol-gel synthetic methods described herein. With reference to FIG. 2, the total number of steps, and specifically the number of energy-intensive steps, are reduced relative to the scheme in FIG. 1. Further, as described above, the disclosed methods allow more intimate mixing and interaction of the components on a smaller scale (e.g., nano-sized, solvated molecule scale), which can mitigate formation of impurities during the synthesis and provides a more homogenous product. Another benefit of the disclosed methods is that the gelation of the organogel precursors in the presence of the lithium transition metal phosphate precursors allows production of cathode materials that are intimately mixed with carbon within a continuous, three-dimensional conductive carbon matrix, while the organogel matrix formed during gelation inhibits phase separation of the reaction components.

In another aspect, phase separation of the reaction components may be inhibited during removal of a liquid phase (e.g., water), immiscible solvent, a precursor (e.g., aqueous phosphoric acid), or combinations thereof from various solutions, suspensions, or emulsions disclosed herein. During such removal, e.g., by drying or concentrating of a solution, suspension, or emulsion, the formation of a self-supporting solid phase comprising the various components may serve the same role as that of a self-supporting solid phase organogel formed by gelation of a gel precursor in the presence of a gelation intiator.

As a general, non-limiting description, the disclosed method generally comprises combining a group of precursors for synthesizing the lithium transition metal phosphate cathode material, providing one or more carbon precursors in a fluid state, mixing the group of precursors with the one or more carbon precursors to form a precursor mixture; adding the gelation initiator to the precursor mixture; allowing the one or more carbon precursor to undergo gelation to form a solid organogel; and pyrolyzing the solid organogel to form the lithium transition metal phosphate cathode material within the conductive carbon matrix. Each of the individual components of the method and the preparative operations thereof are described further herein below.

A. Precursors of lithium transition metal phosphate cathode material

The disclosed method comprises combining a group of precursors for synthesizing the lithium transition metal phosphate cathode material and at least a second precursor of the group comprises a liquid phase having a second density, wherein the second density is less than the first density.

### 1. First Precursor

At least a first precursor of the group of precursors comprises a solid phase having a first density greater than 1 gram (g)/cubic centimeter (cc). In some aspects, the density is in a range from about 1 to about 5, such as about 1, about 2, about 3, about 4, or about 5 g/cc.

In some aspects, the group of precursors comprises a first precursor which is a transition metal salt or a transition metal oxide. As used herein, the terms “transition metal salt” and “transition metal oxide” refer to any salt or oxide of a transition metal and may include mixtures of more than one transition metal. As used herein, the term “transition metal” refers to any metal element in the d-block of the periodic table, which includes groups 3 to 12 on the periodic table, excluding the platinum group metals. The transition metal salt or oxide may include various oxidation states of the transition metal. With respect to oxides, these may include, but are not limited to, monoxide, dioxide, and the like, depending on the valence of the particular transition metal (e.g., 2⁺, 3⁺, 4⁺, or 5⁺). Generally, the transition metal or metals present in the salt or oxide is in a (II) or (III) oxidation state. Suitable transition metals include, for example, vanadium, titanium, manganese, iron, cobalt, copper, and nickel. Particularly suitable transition metals include one or more of manganese, iron, and vanadium. The selection of specific transition metals in the form of their respective salts, oxides or mixed oxide may be determined by one of skill in the art based on the intended battery cell voltage or other performance parameters, availability, cost, toxicity, and other variables.

In some aspects, the first precursor comprises a transition metal oxide. The particle size of the transition metal oxide (e.g., an iron oxide, such as Fe₃O₄ and/or Fe₂O₃) suitable for use in the disclosed method may vary. Generally, small particle sizes, such as about 5 microns or less, are particularly suitable as such particle sizes allow intimate contact of the transition metal oxide with other reaction components (e.g., lithium and phosphate ions and organogel precursor materials). In some aspects, the transition metal oxide has an average particle size of about 5 microns or less, such as in a range from about 1 to about 5 microns. In some aspects, the transition metal oxide may be synthesized (as described below) to have an average particle size of about 5 nanometers (nm) to about 200 nm, such as in a range from about 20 nm to about 100 nm. Alternatively, a transition metal oxide having an average particle size of about 5 microns or greater may be milled to provide the desired particle size range. Such milling can be performed prior to mixing with other reaction components or may be performed in situ as described further herein below.

The density of the transition metal oxide prior to use in the disclosed method may vary. Generally, a high tap-density transition metal oxide is particularly suitable. As used herein, the term “high density” refers to a material having a tap density of greater than about 1.1 g/cm³. Without wishing to be bound by any particular theory, it is believed that a high tap density transition metal oxide serves to template the physical properties of the final lithium iron phosphate cathode material (e.g., via an “isomorphic” reaction), leading to a desirably high density of the product. A high-density cathode material is considered desirable for battery applications, as more power is produced per unit volume of the cathode material (i.e., a greater volumetric energy density is provided). Surprisingly, in some aspects, the disclosed method provides a cathode material with a tap density of about 0.8 g/cm³ or greater, such as in a range from about 0.8 to about 1.1 g/cm³. The tap density of the cathode materials of the present disclosure are therefore in the range of commercial viability (i.e., are comparable to those of previously available LFP's).

In some aspects, the transition metal of the transition metal oxide comprises manganese, vanadium, iron, or combinations thereof. In some aspects, the transition metal of the transition metal oxide is manganese or vanadium.

In some aspects, the transition metal of the transition metal oxide is manganese. Examples of suitable manganese oxides include, but are not limited to, MnO, MnO₂ and Mn₂O₃. In some aspects, the transition metal oxide is a manganese (II) oxide (MnO) or manganese (III) oxide (Mn₂O₃),

In some aspects, the transition metal oxide is a vanadium oxide, such as V₂O₃, VO₂, or V₂O₅. In some aspects, the transition metal oxide is a vanadium oxide, and the lithium vanadium phosphate cathode material has a Li₃Sc₂ (PO₄)₃ structure type.

In some aspects, the transition metal of the transition metal oxide is iron. The oxidation state of the iron in the iron oxide may vary. For example, the iron oxide may be iron (II) oxide (FcO), iron (III) oxide (Fe₂O₃), or a combination thereof (e.g., Fe₃O₄).

In particular aspects, the iron oxide is iron (III) oxide (Fe₂O₃). Iron (III) oxide is an inexpensive and readily available oxide which is stable with respect to oxidation, and therefore requires no special handling (e.g., to avoid oxidation, as may be the case with iron (II) oxide). Further, iron oxide (e.g., Fe₂O₃) having an average particle size of about 5 microns or less may be obtained commercially. Commercial bulk Fe₂O₃ (i.e., Fe₂O₃ having a particle size greater than about 1 microns) may be milled to produce the desired nanoparticulate material, but this is a time-consuming and energy-intensive process. Such downsized Fe₂O₃ is referred to herein is “nanoparticulate iron (III) oxide” and may have an average particle size in a range from about 10 nanometers up to about 100 nanometers, such as in a range from about 30 to about 50 nanometers). However, such nanoparticulate iron (III) oxide is prohibitively expensive on a commercial scale. Surprisingly, according to the present disclosure, it has been found that inexpensive and readily available iron (II) oxalate (FeC₂O₄) may be heated in air with liberation of carbon dioxide to provide nanoporous iron (III) oxide. For example, heating iron oxalate in an air atmosphere to a temperature in a range from about 350 to about 450° C. for about 1 hour was found to convert the iron oxalate to nanoporous iron (III) oxide. Notably, the iron (III) oxide particles produced by thermal decomposition of iron oxalate have an average particle size on the order of several microns but develop internal percolating porosity with pore diameters on the order of 100 nm. Accordingly, such particles are referred to herein as “nanoporous.” In some aspects, Fe₂O₃ obtained by thermal decomposition of FeC₂O₄·2H₂O has a BET nitrogen surface area of about 9.95 m²/g.

In some aspects, the iron oxide is in the form of magnetite (Fe₃O₄) or maghemite (Fe₂O₃) or a solid-solution or mixture of both, with an average composition Fe₃₋ₓO₄, (0≤x≤0.33), herein referred to as magnetic iron oxide nanoparticles (magnetic IONPs). Such IONPs may be purchased or may be prepared according to known methods. In some aspects, the IONP is prepared by oxidation of iron by air in an electrochemical cell. According to the present disclosure, it has been found that certain types of carbon aerogels or other porous carbon structures (e.g., carbonized polyurethane foam, combinations of carbon aerogel within pores of a carbonized polyurethane foam) may act as an “air cathode” to catalytically reduce oxygen at room temperature. When arranged in an electrochemical cell with aqueous electrolytes, oxygen can be reduced into hydroxide anions while oxidizing transition metals such as iron. In some aspects iron is oxidized to produce iron hydroxide, magnetite, maghemite, or a combination thereof. The catalytic effect of carbon aerogels described herein may be used to oxidize iron in the solid state at room temperature (e.g., from 5° C. to 25° C.).

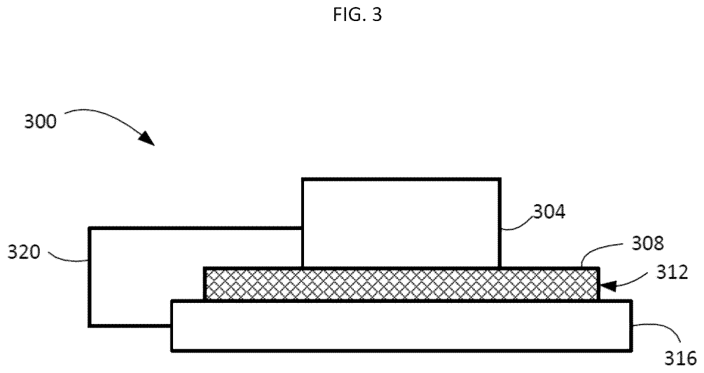

FIG. 3 is a schematic illustration of a system 300 used to oxidize iron at room temperature, according to one or more aspects described herein. The system 300 includes a porous conductive carbon element 304, a separator 308, electrolyte 312, an electrode 316 comprising iron, and a conductor 320. While not wishing to be bound by theory, it is believed that the carbon aerogel element 304 may reduce the activation energy for the reduction of oxygen, thereby enabling the electrically connected iron electrode to participate in a room temperature redox reaction.

In various aspects, the porous conductive carbon element 304 (equivalently referred to as a “substrate”) may be synthesized and/or produced according to techniques including pyrolysis of a polyimide aerogel. In some examples, the pyrolyzed polyimide aerogel may include residual nitrogen or other heteroatoms (i.e., non-carbon atoms) that are not removed during aerogel synthesis or pyrolysis. Using the porous conductive carbon element 304 as a catalyst to oxidize the iron electrode 316 may generate cathode precursor materials that include, but are not limited to Fe(OH)₂, Fe(OH)₃, Fe₃O₄, and Fe₂O₃. The process described herein may produce the iron oxide/hydroxide in the solid state without producing large quantities of wastewater using air, water, and iron metal as the only reactants.

While many of the aspects described herein describe the use of a carbon aerogel element in an electrochemical cell, aspects herein are not limited to those that include a carbon aerogel. More generally, the porous conductive carbon element 304 may be any of a variety of porous carbon substrates that may act as an air cathode. While carbon aerogel materials (e.g., polyimide derived carbon aerogel) are believed to support a high rate of oxidation of transition metals such as iron at room temperature, other porous carbons may also have the same effect under the proper experimental conditions. Additional examples of porous carbon substrates that may be used instead of, or in addition to, carbon aerogel substrates include, but are not limited to porous graphitic carbon substrates, carbon substrates made from carbon nanotubes, carbonized polymer foams (e.g., carbonized polyurethane foam), carbon fullerenes, graphene, graphene oxide, and/or activated carbon. In some examples, the specific surface area of these substrates may be at least 100 m²/g. For example, porous conductive carbon elements 304 of the present disclosure may be a carbon aerogel having a specific surface area in the range of the non-pyrolyzed aerogel precursors (e.g., from 100 m²/g to 600 m²/g). The porous conductive carbon element 304 may be a carbon aerogel in a monolithic form, a particulate form, or combinations thereof.

In certain aspects, porous conductive carbon materials or compositions of the present disclosure have an electrical conductivity of about 1 Siemens(S)/centimeter (cm) or more, about 5 S/cm or more, about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

In some examples, the rate of the redox reaction (and more specifically, the oxidation of the iron metal) may be selected (e.g., increased or decreased relative to a reference reaction rate) by modifying one or more conditions under which the reaction is performed. In some examples, the rate of reaction may be increased by one or more of: increasing a temperature at which the reaction is performed, increasing a partial pressure of oxygen (thereby increasing a rate of hydroxy anion production), increasing a concentration of electrolyte (e.g., from a 1 molar (M) solution to a multiple molar solution), and/or increasing the magnitude of the electrical potential difference applied to the carbon aerogel/transition metal system 300. Similarly, a rate of reaction can be decreased by limiting any of the foregoing parameters. Changing a pH of the electrolyte or the composition of the electrolyte may also affect the rate of the reaction as well as the composition and morphology of the reaction product(s). In addition, it has been unexpectedly found that reducing a concentration of electrolyte (e.g., from 1M to 0.2M) and/or altering an electrolyte cation (e.g., from Na⁺ to K⁺) may reduce an average diameter of nanoparticle from approximately 100 nm to as low as from 5 nm to 20 nm. These nanoparticles may in turn, be advantageously reacted to form similarly size lithium metal phosphate cathode materials having exceptionally high surface area (described below in Table 1).

In some examples, excluding gases other than oxygen may influence the reaction product. For example, using pure oxygen or a mix of gases that excludes carbon dioxide may reduce the presence of carbonate species in the reaction product. This in turn may reduce and/or eliminate the presence of undesired reaction products (e.g., carbonates) in the oxidized iron metal compounds.

The separator 308 is an electrically insulating material that provides a structure through which ions may travel. This combination prevents electrical shorting of the system 300 while enabling current flow via ionic transfer between the porous conductive carbon element 304 and the iron metal electrode 316. Examples of separator 308 may include cellulose-based papers, fibrous polymer fabrics or felts, among others.

The electrolyte 312, disposed within the separator 308, facilitates ionic transfer from the porous conductive carbon element 304 to the iron metal electrode 316. Examples of the electrolyte include aqueous (e.g., distilled water, deionized water, distilled deionized water, tap water) solutions of sodium chloride (NaCl_{(aq)}), ammonia chloride (NH₃Cl_{(aq)}), sodium carbonate (NaCO_{3(aq)}), potassium chloride (KCl), among others. In some examples, a concentration of the electrolyte may be saturated with solute. In other examples, a concentration of the electrolyte may be less than a saturated solution. In some examples, a concentration of the electrolyte may be selected according to various criteria including, but not limited to a desired rate of reaction at the iron metal anode (higher concentrations generally accelerating an oxidation rate), a morphology and/or configuration of the oxide reaction product at the iron metal anode, among others.

While not wishing to be bound by theory, it has been observed that the presence of chloride in the electrolyte promotes separation of the hydroxylated reaction product from the surface of the iron metal electrode 316. Thus, when using a chloride-containing electrolyte, the process may naturally convert an entire mass of the iron metal electrode 316 to the reaction product because a fresh surface of the iron metal electrode 316 is naturally exposed as the reaction progresses.

The iron metal electrode 316 may be a piece of iron metal that is in electrical and ionic communication with the porous conductive carbon element 304 as illustrated in FIG. 3. In some examples, the iron metal electrode 316 may include compositional components that are added to improve conductivity improve oxidation reaction kinetics, or both

The conductor 320 may be an electrical conductor, such as a copper wire, an aluminum wire, a gold wire, and alloys thereof that connects the carbon aerogel element 304 and the transition metal electrode 316. In some examples, the conductor 320 may also be used to apply an electrical potential to the system 300 that initiates and sustains the oxidation reaction at the iron metal electrode 316.

A minimum applied electrical potential, applied in some examples via the conductor 320 from an external source, varies depending on the iron metal selected for the iron electrode 316. The minimum applied electrical potential needed to promote an oxidation reaction at the iron metal oxide 316 may be an indication of the catalytic activity of the carbon catalyst used to reduce oxygen (e.g., for hydroxy anion generation) relative to the iron metal electrode 316. A maximum electrical potential may be selected to avoid electrolysis (electrically induced decomposition) of the electrolyte.

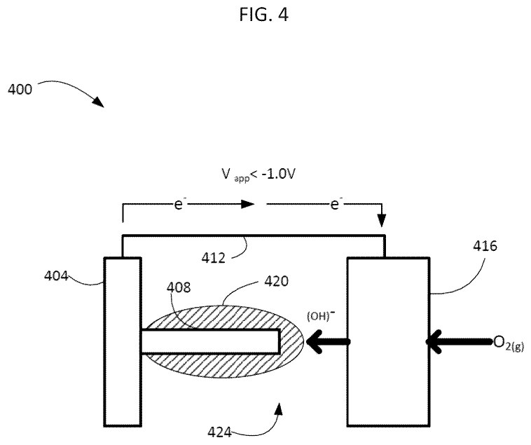

FIG. 4 is a schematic illustration of an electrochemical cell 400 according to an aspect of the present disclosure. The electrochemical cell 400 is an alternative representation of some aspects of the system 300. The electrochemical cell 400 includes an electrode 404, an iron metal component 408, a conductor 412, a porous conductive carbon element 416, an oxidation reaction product layer 420, and electrolyte 424.

Many of the elements shown in the electrochemical cell 400 of FIG. 4 are analogous to elements described above in the context of the system 300 shown in FIG. 3. The electrode 404 may be an electrical contact to which the iron metal component 408 (analogous to iron metal electrode 316) is in electrical communication. The conductor 412 is analogous to the conductor 320. The porous conductive carbon element 416 is analogous to the porous conductive carbon element 304.

In addition to the elements already described in the context of FIG. 3, FIG. 4 schematically illustrates the redox reactions that occur within the electrochemical cell 400 upon application of an external electrical voltage having a magnitude of 1 volt (V). A magnitude of the minimum value of an applied voltage needed to promote oxidation reactions (“onset voltage”) may be determined by the particular transition metal (i.e., iron) of the component 408 and the catalytic efficiency of the porous conductive carbon element 416. In some examples, oxidation of the iron metal within the electrochemical cell 400 may not occur for applied voltages having a magnitude less than the minimum value.

In particular, FIG. 4 schematically illustrates the exposure of the porous conductive carbon element 416 to oxygen. In some examples, the oxygen may be gaseous such as from air or a commercial gas mixture with a concentration of oxygen that is higher than that found in air. Oxygen may enter the porous conductive carbon element 416 that has been previously wetted with electrolyte 424. The oxygen, upon encountering the porous conductive carbon element 416 that also contains and/or is coated with the electrolyte 424, may be ultimately converted into hydroxy anions solvated by the electrolyte 424.

The hydroxy anions may then react with the oxidized iron metal component 408 to form one or more of iron metal oxides, hydroxides, and/or other reaction products 420 resulting from the reaction of iron metal and hydroxy anions. These reaction products are indicated by shaded region 420 in FIG. 4. While the reaction products 420 as shown in FIG. 4 are in direct contact with the iron metal component 408, this need not be the case. As indicated above, different electrolyte compositions may produce different physical configurations in the reaction products 420. For example, the presence of chloride in the electrolyte 424 produces reaction products 420 that separate from the iron metal component 408.

In some examples, oxygen is the cathode in the electrochemical cell 400. That is, the oxygen that encounters the porous conductive carbon element 416 (which functions as an “air cathode”) is reduced upon operation of the electrochemical cell 400. The arrows in FIG. 4 labeled “c” indicate that oxygen entering the carbon aerogel element 416 is the recipient of electrons generated by operation of the electrochemical cell 400. Because the quantity of oxygen may be from an inexhaustible source (e.g., from earth's atmosphere) or from a source with a number of moles that equals or exceeds the moles of iron metal in the electrode 408, the iron metal electrode 408 may optionally be reacted to completion. In particular, the iron metal electrode 408 may be reacted to completion when fresh reaction surfaces are exposed upon separation of the reaction product 420 from the iron metal component 408. In other examples, the iron metal electrode may be reacted partially or completely upon diffusion of hydroxyl ions through an adhering layer of reaction product 420 to unreacted portions of the iron metal electrode 408. The electrolytic reaction proceeds to oxidize the iron metal 408 to produce “green rust” which is iron (II) hydroxide Fe(OH)₂ and/or its partially oxidized form, Fe(OH)₂₋ₓOₓ. In practice, this material falls to the bottom of the reaction chamber and can be removed, for example by gravity or by pumping to a separate chamber. In the separate chamber the (partially oxidized) iron hydroxide may be treated with air in basic conditions (e.g., pH >8) to yield magnetic IONPs.

The operation of the electrochemical cell and formation of the oxidized iron metal products (e.g., a ferromagnetic iron compound, a ferrimagnetic iron compound, or both) may be performed at various temperatures. In some aspects, operation is at a temperature between 15° C. and 35° C.

While the preparation of oxidized iron metal products is described herein, it is noted that the electrochemical/air oxidation process is not limited to iron. Other metals may be used, and one of skill in the art will recognize suitable metals and their oxidation products. While not wishing to be bound by theory, it is believed that with all metals (M) capable of forming stable divalent cations (e.g., Fe, Mn, Ni, Co, Cu, Zn, Sn, etc.), the immediate reaction product formed at the surface of the M anode is the corresponding metal double hydroxide salt, M(OH)₂. With metals for which +2 is the highest possible oxidation state (e.g., Zn) or where oxidation states higher than +2 are not energetically favorable to form at low temperature in air (e.g., Ni, Co, Cu), M(OH)₂ seems to be the final reaction product as well. For the specific case of Fe(and Mn), as +3 oxidation states are readily available in air at low temperature, M(OH)₂ tends to be an intermediate, leading to higher oxidation states depending on the potential-pH conditions as described herein below.

Magnetic IONPs (e.g., magnetite, maghemite, and/or their solid solutions) are ferrimagnetic and can be magnetically separated from the reaction mixture (noting that iron hydroxide is paramagnetic). The recovered magnetite is then washed and dried for onward processing for example as the iron source in LFP synthesis.

Magnetic IONPs produced as described above have undergone XRD analysis and it has been confirmed that the observed XRD pattern matches the calculated pattern of the cubic spinel. The magnetic particles produced in this method are in the form of nanoparticles i.e., particles having a size in the region of 20-100 nm when observed using scanning electron microscopy. It has surprisingly been observed that the concentration of the electrolyte used in the process may have an influence on the particle size of the produced particles.

In the specific example of Fe, it appears that Fe(OH)₂ and/or its partially oxidized form, FeOₓ(OH)₂₋ₓ, (i.e., the “green rust”), is the first intermediate that forms. In some aspects, the iron hydroxide/oxide product is ferrous hydroxide (Fe(OH)₂) or the partially oxidized form (iron oxyhydroxide; FeOₓ(OH)₂₋ₓ). Accordingly, in some aspects, the method further comprises oxidative conversion of the iron hydroxide or iron oxyhydroxide to, respectively, magnetite (Fe₃O₄) or maghemite (Fe₂O₃). In some aspects, the oxidative conversion comprises aeration under alkaline conditions. Without any specific further treatment at neutral pH, green rust oxidizes slowly to goethite, FeOOH. On the other hand, increasing the pH to above 8 and controlled oxidation by air yields magnetite (Fe₃O₄) with dehydration. Further oxidation of magnetite by air gives maghemite (Fe₂O₃; or Fe8/3V1/3O4 in magnetite's spinel notation, where V=Vacancy). Due to availability of the +3-oxidation state for manganese, similar transformations are expected.

In some aspects, the electrochemical aero-oxidation of iron is performed in an alkaline environment, which yields forms of iron oxide/hydroxide that are not magnetic. In other aspects, the electrochemical aero-oxidation of iron is performed as described herein above, and the resulting iron hydroxide or iron oxyhydroxide is isolated and subsequently exposed to an aqueous environment having a pH of greater than about 8, such as about 8, about 9, or about 10, up to about 11, about 12, about 13, or about 14, and then contacted with an oxygen source, such as air. In one aspect, air is bubbled through the iron hydroxide/oxyhydroxide suspended or dissolved in an alkaline aqueous system. Such alkaline aqueous systems may be provided by, for example, a solution of a base, such as a carbonate or hydroxide, in water.

In some aspects, the iron hydroxide/oxide product does not require purification and/or washing to remove contaminants. For examples in which sodium chloride is present in the electrolyte, the reaction product may include benign sodium chloride (NaCl) that may simply be removed by washing the reaction products with water. Sodium chloride is less environmentally polluting and poses a lower threat to human health than the sulfates and ammonia produced by alternative processing techniques. For examples in which the electrolyte includes ammonium chloride (NH₄Cl), remediation is also less problematic than other process. Ammonium chloride decomposes to a gaseous mixture of NH₃ and HCl at 338° C. during calcination. The temperature of the gas mixture may be reduced below 338° C. after evolution of the gases so that NH₄Cl condenses back into solid form, which can be recycled. For this reason, an impurity of NH₄Cl salt requires no washing and therefore produces no wastewater.

In some aspects, the IONP is magnetic, such as magnetite, maghemite, or their solid-solution or mixture, and is separated from the electrolyte 424 by a magnetic process. Particularly, exposing the oxide product 420 to a magnetic field (e.g., from a permanent or electromagnet) causes the magnetic IONP product to be attracted to and retained by the magnetic field. The retained magnetite may then be washed, for example with water, and subsequently collected. For example, the magnetic field may be removed, or the magnetite may be physically separated from the magnet. The magnetic IONP may optionally be dried by any suitable conventional means or may be utilized in the disclosed methods as described below in wet or partially dry form. Because magnetite and maghemite exhibit microwave susceptibility, these reaction products may be heated, and therefore dried, using microwave radiation which is more energy efficient than using indirect heating via a furnace.

In some aspects, the group of precursors includes a precursor having microwave susceptibility. In one particular aspect, magnetite is a preferred transition metal oxide in view of the microwave susceptibility of magnetite (i.e., it is a microwave susceptor). By receiving microwave energy and converting it to heat, the magnetite enables carbonization of the organogel and conversion of the reactants into LFP without wasteful and energy-inefficient furnace processing. As magnetite is consumed during the reaction and carbonization process, its microwave susceptibility decreases. However, during consumption of the magnetite, the organogel is increasingly converted into carbon. Because carbon is also a microwave susceptor, it converts progressively more microwave radiation into heat, thereby sustaining the conversion of the reactants into LFP. The magnetic susceptibility (e.g., ferrimagnetic, paramagnetic, or both) of these components also supports microwave drying of reagents and the finished LFP without resorting to energy-intensive and inconvenient thermal drying.

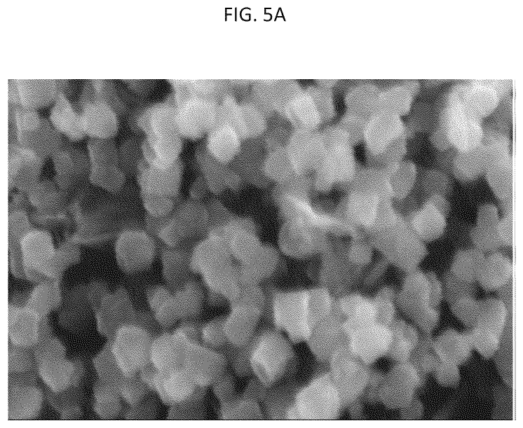

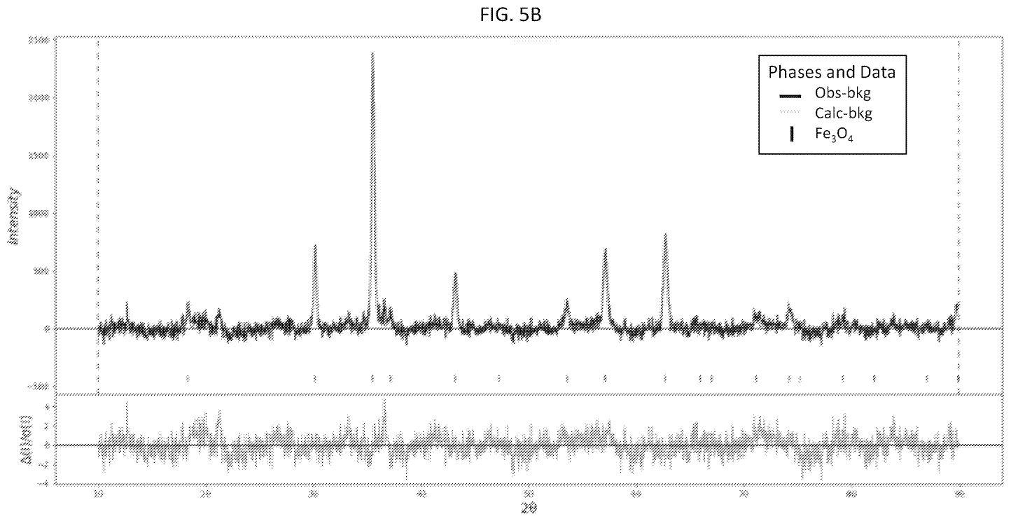

In some aspects, the iron oxide produced by the disclosed aero-anodization process is nanoparticulate. A scanning electron photomicrograph of nanoparticulate iron oxide produced by the acro-anodization described herein above is provided as FIG. 5A, which shows the average (roughly cubic) particle size to be about 60 nm. Surprisingly, it has been found that the average particle size may be reduced by reducing the concentration of the electrolyte and/or changing the electrolyte anion from Na⁺ to K⁺. A powder x-ray diffractogram is provided as FIG. 5B, demonstrating the cubic structure of the Fe₃₋ₓO₄ (0≤x≤0.33) product. In some aspects, the IONPs are formed as a solid-solution of magnetite-maghemite with composition Fe₃₋ₓO₄ (0≤x≤0.333). In such aspects, the oxidation state of iron is between 2.67 and 3. The nitrogen sorption BET surface area of IONPs prepared as disclosed may vary with, for example, changes in the electrolyte identity and concentration. For example, it has been found according to the present disclosure that Fe₃₋ₓO₄ obtained using 1 M NaCl as the electrolyte had a BET surface area of 22.46 m²/g, while Fe₃₋ₓO₄ obtained with 0.2 M KCl as the electrolyte had a BET surface area of 40.22 m²/g. Thus, the process may be tailored to produce particles of different size, depending on the intended end-use. The term “size” in this case refers to a characteristic dimension of a particle. For roughly spherical particles, a characteristic dimension may be a diameter. In other cases, depending on the shape of the particle, a characteristic dimension may be one or more of a width, length, and/or depth.

Table 1 presents particle size and specific surface area data for iron oxides and the corresponding LFPs of the disclosure prepared therefrom under various experimental conditions as described herein. It will be noted that some examples include ball milling to access specific surface areas that are unexpectedly as much as 10 times greater than commercially available materials.

TABLE 1
Particle size and specific surface area data
for iron oxides and corresponding LFPs

| | Specimen | Specific surface | Particle |
|---|---|---|---|
| # | ID | area (m²/g) | size (nm) |
| 1 | α-Fe₂O₃ | 9.9463 | ~100 |
| 2 | γ-Fe₂O₃ | 22.4580 | ~60 |
| 3 | γ-Fe₂O₃ | 40.2216 | ~30 |
| 4 | LFP/C^{a} | 6.9025 | 1000-10000 |
| 5 | LFP/C^{b} | 62.1353 | 20-1000 |
| 6 | LFP/C^{b} | 20.4529 | 20-1000 |
| 7 | LFP/C^{b} | 9.9468 | 100-5000 |
| 8 | LFP/C^{a} | 21.8997 | 100-500 |
| 9 | LFP/C^{a} | 20.9905 | 50-500 |

^{a}LFP embedded inside a carbon network
^{b}LFP particles are loosely in contact with carbon particles as a result of ball milling

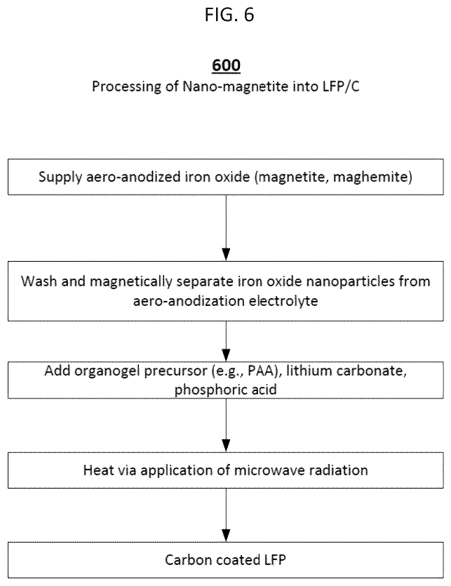

The disclosed aero-anodization method of preparing magnetic IONPs may be implemented in a semi-continuous or continuous process, particularly when combined with magnetic separation and washing. A non-limiting flow diagram of a production scheme for semi-continuous synthesis of magnetite is provided as FIG. 6. Each of the processes shown in FIG. 6 are described herein in different contexts and require no further explanation.

In some aspects, the transition metal of the transition metal oxide is a combination of manganese and iron (e.g., an iron-manganese mixed oxide). In some aspects, the transition metal oxide is a mixed iron-manganese oxide having a formula Fe₃₋ₓMnₓO₄, where 0.0≤x≤ 1.5. In some aspects, the resulting lithium transition metal phosphate cathode material has a formula LiFe_{1-y}Mn_{y}O₄, where 0.0≤y≤0.5.

### 2. Second Precursor

i. Phosphoric Acid

At least a second precursor of the group of precursors comprises a liquid phase having a second density, wherein the second density is less than the first density (e.g., less than about 1, less than about 2, less than about 3, less than about 4, or less than about 5 g/cc).

In some aspects, the group of precursors comprises a liquid phase comprising aqueous phosphoric acid (H₃PO₄). The aqueous solution of phosphoric acid is generally provided by adding the desired volume of concentrated phosphoric acid to the desired volume of water. The volume of the aqueous solution and the quantity of phosphoric acid present in the solution (i.e., the concentration) may vary. Generally, the phosphoric acid is provided in a quantity to provide a molar ratio of transition metal to phosphate (PO₄³⁻) of about 1:1 for LiMPO₄ cathode families and 1:1.5 for Li₃M₂(PO₄)₃ cathode families. In some aspects, the volume of the aqueous solution is selected to provide a phosphoric acid concentration in a range from about 0.1 to about 10 Molar (i.e., moles per liter), or from about 1 to about 5 Molar, such as about 2 to 3 Molar.

ii. Lithium-Ion Source

In some aspects, the liquid phase comprises a source of lithium ions. Any lithium compound which is water soluble or capable of dissolution in aqueous phosphoric acid may be used. Examples of suitable lithium salts include, but are not limited to, lithium hydroxide, carbonate, acetate, chloride, and the like. One particularly suitable lithium-ion source is lithium carbonate (Li₂CO₃), which is relatively inexpensive and readily available. Lithium carbonate gradually dissolves in aqueous phosphoric acid with the evolution of carbon dioxide gas. At least a portion of the lithium ions present may be associated with phosphate ions as lithium phosphate monobasic. The amount of lithium-ion source (e.g., lithium carbonate) added may vary. Generally, the lithium-ion source is added in an amount sufficient to provide a molar ratio of lithium ions to phosphate and transition metal ions of about 1:1:1.

iii. Alternatives to First or Second Precursors

While the first precursor and second precursor have been described above with respect to transition metal oxides and lithium/phosphoric acid, respectively, it is contemplated here in that the identities of the first precursor and second precursor may be reversed. Accordingly, the description of first and second precursor is not intended to be limited to the foregoing aspects.

Further, other sources of transitional metals (e.g., iron) are contemplated herein. For example, the transition metal may be iron, but the source may be other than an oxide. Such alternatives are now described.

### Alternative Transition Metal Source (Iron Oxalate)

In some aspects, the transition metal is iron, and the source of the iron is iron oxalate. It has surprisingly been found according to the present disclosure that iron oxalate may be used directly in the method without first converting to iron (III) oxide. Accordingly, in another aspect the method comprises combining iron oxalate (FeC₂O₄), aqueous phosphoric acid (H₃PO₄), and lithium carbonate as the group of precursors. The resulting lithium iron phosphate cathode material within a conductive carbon matrix was found to possess a comparable nanoparticulate morphology to that prepared by a sequential method (where the iron oxalate is first converted to iron (III) oxide).

In some aspects, the transition metal is iron, and the source of iron is iron oxalate. However, in this permutation, the iron oxalate is first converted to an iron phosphate, which is allowed to react with lithium carbonate and one or more organogel precursor materials. Accordingly, in another aspect the method comprises combining iron oxalate (FeC₂O₄) and aqueous phosphoric acid (H₃PO₄) to form a mixture of iron phosphates having the formula Feₓ(PO₄)_{y} wherein x is 1 and y is 1, or wherein x is 3 and y is 2, and combining the mixture of iron phosphates with a source of lithium ions. Without wishing to be bound by theory, it is believed that the chemical reactions occurring during the mixing and pyrolysis may be represented by the following equations:

$$3 {{Fe}_{2} ( {C}_{2} {O}_{4} )}_{3} + 2 {H}_{3} {PO}_{4} à {{Fe}_{x} ( {PO}_{4} )}_{y} + 3 {H}_{2} {C}_{2} {O}_{4} \qquad ( 1 )$$

$$for$$

$$x = y = 1$$

$${{Fe}_{x} ( {PO}_{4} )}_{y} + \frac{1}{2} {Li}_{2} {CO}_{3} + PAA / {H}_{2} O à LFP / C \qquad ( 2 )$$

$$for$$

$$x = y = 1$$

$${{Fe}_{x} ( {PO}_{4} )}_{y} + {Li}_{3} {PO}_{4} + PAA / {H}_{2} O \to LFP / C \qquad ( 3 )$$

$$for$$

$$x = 3 , y = 2.$$

Alternative transition metal source (iron and manganese sulfates)

In some aspects, the transition metal is iron and manganese. In one permutation, iron sulfate and manganese sulfate are allowed to react together with oxalic acid to form a mixed oxalate, which is converted to a mixed iron-manganese oxalate, which is allowed to react with lithium carbonate, and phosphoric acid. Accordingly, in another aspect is provided a method comprising: combining iron (II) sulfate, manganese (II) sulfate, and oxalic acid in water, forming a precipitate of a mixed iron-manganese oxalate of formula Fe₁₋ₓMnₓC₂O₄; exposing the mixed iron-manganese oxalate to air at a temperature in a range from about 350 to about 450° C. for a period of time sufficient to convert the mixed iron-manganese oxalate to a nanoporous mixed iron-manganese oxide of formula Fe₂₋₂ₓMn₂ₓO₃ₜ or Fe₃₋ₓMnₓO₄ suspending the nanoporous mixed iron-manganese oxide in an aqueous solution of phosphoric acid (H₃PO₄); mixing the suspension for a period of time; and adding a source of lithium ions to the suspension to form a reaction mixture. The lithium iron manganese phosphate cathode material thus prepared has a formula LiFe₁₋ₓMnₓPO₄ where x is [0≤x≤1]. The nanoporous mixed iron-manganese oxide of formula Fe₂₋₂ₓMn₂ₓO₃ prepared by the decomposition of the corresponding mixed oxalate has been found according to the present disclosure to have particles of an average size on the order of several microns; however, high-resolution imaging reveals the presence of internal percolating porosity where the diameter of the pores is about 100 nm. Further, the Fe₂₋₂ₓMn₂ₓO₃ obtained by thermal decomposition of Fe₁₋ₓMnₓC₂O₄·2H₂O was found to have a BET nitrogen surface area of about 11.93 m²/g.

Without wishing to be bound by theory, it is believed that the chemical reactions occurring during the mixing and pyrolysis may be represented by the following equations:

$$x {FeSO}_{4} + 1 - x {MnSO}_{4} + {H}_{2} {C}_{2} {O}_{4} + {H}_{2} O à {Fe}_{x} {Mn}_{1 - x} {C}_{2} {O}_{4 ( s )} + {H}^{+} ( aq ) + {SO}_{4 ( aq )}^{2 -} \qquad ( 1 )$$

$${Fe}_{x} {Mn}_{1 - x} {C}_{2} {O}_{4} + air à {Fe}_{2 - 2 x} {Mn}_{2 x} {O}_{3 ( nanoporous )} + {CO}_{2} ( 350 - 450 ° C . ) \qquad ( 2 )$$

$${Fe}_{2 - 2 x} {Mn}_{2 x} {O}_{3 ( nanoporous )} + 2 {H}_{3} {PO}_{4} + {Li}_{2} {CO}_{3} + PAA / {H}_{2} O à LMFP / {C}_{( nanoparticulate )} \qquad ( 3 )$$

In another permutation, iron sulfate and manganese sulfate are allowed to react together with oxalic acid to form a mixed oxalate, which is allowed to react with phosphoric acid and lithium carbonate. Accordingly, in another aspect the method comprises: combining iron (II) sulfate, manganese (II) sulfate, and oxalic acid in water, forming a mixture comprising a mixed iron-manganese oxalate of formula Fe₁₋ₓMnₓC₂O₄; and adding lithium carbonate and aqueous phosphoric acid (H₃PO₄), forming after pyrolysis a lithium iron manganese phosphate having a formula LiFe₁₋ₓMnₓPO₄ where x is [0≤x≤1]. Without wishing to be bound by theory, it is believed that the chemical reactions occurring during the mixing and pyrolysis may be represented by the following equations:

$$x {FeSO}_{4} + 1 - x {MnSO}_{4} + {H}_{2} {C}_{2} {O}_{4} + {H}_{2} O à {Fe}_{x} {Mn}_{1 - x} {C}_{2} {O}_{4 ( s )} + {H}^{+} ( aq ) + {SO}_{4 ( aq )}^{2 -} \qquad ( 1 )$$

$${Fe}_{x} {Mn}_{1 - x} {C}_{2} {O}_{4} + \frac{1}{2} {Li}_{2} {CO}_{3} + {H}_{3} {PO}_{4} + PAA / {H}_{2} O à LMFP / C ( nanoparticulate ) \qquad ( 2 )$$

In yet another permutation, iron sulfate and manganese sulfate are allowed to react together with oxalic acid to form a mixed oxalate, which is allowed to react with phosphoric acid to form an intermediate mixed iron-manganese phosphate. This mixed phosphate is then allowed to react with lithium phosphate. Accordingly, in another aspect the method comprises: combining iron (II) sulfate, manganese (II) sulfate, and oxalic acid in water, forming a precipitate of a mixed iron-manganese oxalate of formula Fe₁₋ₓMnₓC₂O₄; suspending the mixed iron-manganese oxalate in an aqueous solution of phosphoric acid (H₃PO₄) to convert the mixed metallic oxalate to mixed metallic phosphate; and adding lithium phosphate, forming after pyrolysis a lithium iron manganese phosphate having a formula LiFe₁₋ₓMnₓPO₄) where x is [0≤x≤1]. Without wishing to be bound by theory, it is believed that the chemical reactions occurring during the mixing and pyrolysis may be represented by the following equations:

$$x {FeSO}_{4} + 1 - x {MnSO}_{4} + {H}_{2} {C}_{2} {O}_{4} + {H}_{2} O à {Fe}_{x} {Mn}_{1 - x} {C}_{2} {O}_{4 ( s )} + {H}^{+} ( aq ) + {SO}_{4 ( aq )}^{2 -} \qquad ( 1 )$$

$$3 {Fe}_{x} {Mn}_{1 - x} {C}_{2} {O}_{4} + 2 {H}_{3} {PO}_{4} à {( {Fe}_{x} {Mn}_{1 - x} )}_{3} {( {PO}_{4} )}_{2} + 3 {H}_{2} {C}_{2} {O}_{4} \qquad ( 2 )$$

$${( {Fe}_{x} {Mn}_{1 - x} )}_{3} {( {PO}_{4} )}_{2} + {Li}_{2} {PO}_{4} + PAA / {H}_{2} O à 3 {LiFe}_{x} {Mn}_{1 - x} {PO}_{4} / C \qquad ( 3 )$$

### B. Carbon Precursors

The method comprises providing one or more carbon precursors in a fluid state, meaning the mixture comprising them can flow, has no fixed shape, and offers low or no resistance to an external stress. The one or more carbon precursors in a fluid state are configured to form a solid organogel in the presence of a gelation initiator, and the solid organogel is configured to form a conductive carbon matrix upon pyrolysis. In alternative aspects, the solid organogel may be formed through removal of a liquid phase (e.g., solvent) from a solution. For example, in some aspects, partially or completely removing a solvent by drying methods may result in an organogel in the absence of gelation induced by a gelation initiator. Generally, the conductive carbon matrix includes a carbonized form of the organogel and/or its precursor materials and surrounds the LMP particles and/or precursors thereof. The conductive carbon matrix may comprise graphiotic carbon, amorphous carbon, or mixtures thereof. Upon any subsequent milling, the conductive carbon matrix is maintained despite reduction in particle size.

In some aspects, the method comprises mixing the group of lithium transition metal phosphate cathode material precursors with the one or more carbon precursors to form a precursor mixture; adding the gelation initiator to the precursor mixture; and allowing the one or more carbon precursor to undergo gelation to form a solid organogel. As described herein above, it is to be understood that such solid organogels are formed in the presence of precursors to the lithium-transition metal phosphate material, and will therefore comprise such precursors, reaction products thereof, and intermediates ultimately leading to the lithium-transition metal phosphate material upon pyrolysis of the solid organogel comprising such species.

By “carbon precursor” is meant a material which is capable of undergoing a polymerization or other gelation reaction to produce a solid organogel, and which may then be pyrolyzed to form a conductive carbon matrix. Generally, the solid organogel is porous in nature, and is capable of forming a conductive carbon matrix upon exposure to elevated temperature conditions as described herein below. In some aspects, a catalyst or gelation initiator is utilized to initiate and/or complete gelation. Suitable organogels include, but are not limited to, phloroglucinol-furfuraldehyde polymers, resorcinol-furfuraldehyde polymers, phenol-formaldehyde polymers, polyurethanes, melaimine-aldehyde polymers, polyacrylamide polymers, polybenzoxazine polymerspolyamic acids, and polyimides. Each of these organogels and their respective precursor materials (i.e., carbon precursors) and gelation conditions are further described herein below.

### 1. Phloroglucinol-Furfural, Resorcinol-Furfural, and Phenol-Formaldehyde Polymers

In some aspects, the solid organogel is a phloroglucinol-furfural (PF) polymer. In such aspects, the organogel precursor materials are phloroglucinol and furfural. In such aspects, the method generally comprises adding phloroglucinol and furfural to the reaction mixture and allowing the phloroglucinol and furfural to react, forming an organic matrix comprising a PF organogel. Gelation of the phloroglucinol and furfural mixture occurs almost instantaneously (e.g., 30 seconds or less, 15 seconds or less, 5 seconds or less). Accordingly, the phloroglucinol and the furfural are added individually in succession, in either order, to the reaction mixture. In some aspects, the phloroglucinol and furfural are each provided separately as ethanolic solutions. No catalyst or initiator is required. However, in some aspects, a gelation initiator is utilized. In some aspects, the gelation initiator is an amine base or an acid. When the phloroglucinol and the furfural are combined, optionally with the initiator, gelation of the PF polymer occurs rapidly (e.g., in about 30 seconds or less). The resulting PF polymer comprises a number of repeat units (“n”), which may vary depending on reaction conditions and reactant ratios. Generally, the resulting PF organogel possesses a rigid, three-dimensional structure.

In other aspects, the solid organogel is a resorcinol-furfural polymer. Such polymers may be prepared as above but substituting resorcinol for the phloroglucinol.

In still other aspects, the solid organogel is a phenol-formaldehyde (PF) polymer. Such polymers may be prepared as above but substituting phenol for the phloroglucinol and formaldehyde for the furfural.

### 2. Polyurethane Polymers

In some aspects, the solid organogel comprises or is a polyurethane polymer. In such aspects, precursors comprise a polyol and an isocyanate. In some aspects, the polyol is cellulose. In such aspects, the gelation initiator comprises an alkylamine (e.g., triethylamine).

### 3. Polyamic Acid

In some aspects, the organogel is a polyamic acid. Polyamic acids are polymeric amides having repeat units comprising carboxylic acid groups, carboxamido groups, and aromatic or aliphatic moieties which comprise the diamine and tetracarboxylic acid from which the polyamic acid is derived. A “repeat unit” as defined herein is a part of the polyamic acid (or a corresponding polyimide) whose repetition would produce the complete polymer chain (except for the terminal amino groups or unreacted anhydride termini) by linking the repeat units together successively along the polymer chain. One of skill in the art will recognize that the polyamic acid repeat units result from partial condensation of tetracarboxylic acid dianhydride carboxyl groups with the amino groups of a diamine.

In some aspects, the polyamic acid is any commercially available polyamic acid. In other aspects, the polyamic acid has been previously formed (“‘pre-formed’”) and isolated, e.g., prepared by reaction of a diamine and a tetracarboxylic dianhydride in an organic solvent according to conventional synthetic methods. In either case, whether purchased or prepared and isolated, a suitable polyamic acid is in substantially pure form. Pre-formed and isolated or commercially available polyamic acids may be in, for example, solid form, such as a powder or crystal form, or in liquid form.

Suitable polyamic acids, polymides, and methods of preparing them are provided in, for example, U.S. Patent Application Publication No. US2022/0069290 to Zafiropoulos, and in U.S. patent application Ser. No. 17/546,761 to Leventis and Ser. No. 17/546,529 to Begag, each of which are incorporated herein in their entirety.

In some aspects, the polyamic acid is provided in the form of a water-soluble salt, which may then be precipitated from the reaction mixture as the insoluble polyamic acid by acidification of the reaction mixture. In such aspects, the organogel precursor material is a polyamic acid ammonium or alkali metal salt, and the method further comprises adding a gelation initiator to the reaction mixture.

In some aspects, the organogel precursor material is a polyamic acid ammonium salt, including, but not limited to, ammonium salts comprising a trialkylamine. In some aspects, the ammonium salt is a salt of the polyamic acid with trimethylamine, triethylamine, tri-n-propylamine, tri-n-butylamine, N-methylpyrrolidine, N-methylpiperidine, diisopropylethylamine, or a combination thereof. In some aspects, the ammonium salt is a salt of the polyamic acid with triethylamine. In some aspects, the ammonium salt is a salt of the polyamic acid with diisopropylethylamine.

In some aspects, the organogel precursor material is an alkali metal salt of a polyamic acid, such as a lithium, sodium, or potassium salt.

The gelation initiator is generally an acid or a substance which may be hydrolyzed to form an acid. One non-limiting example of a suitable acid is acetic acid. One non-limiting example of a suitable substance which may be hydrolyzed to form an acid is acetic anhydride. Accordingly, in some aspects, the method comprises adding acetic acid, acetic anhydride, the native protonated phosphate, or a combination thereof as the gelation initiator. In some aspects, the method comprises adding acetic anhydride and allowing the acetic anhydride to hydrolyze, forming acetic acid and inducing gelation of the polyamic acid.

### 4. Polyimide

In some aspects, the solid organogel comprises or is a polyimide. In some aspects, the polyimide is formed from imidization of a polyamic acid. Suitable polymides and methods of preparing them are provided in, for example, U.S. Patent Application Publication No. US2022/0069290 to Zafiropoulos, and in U.S. patent application Ser. No. 17/546,761 to Leventis and Ser. No. 17/546,529 to Begag, each of which are incorporated herein in their entirety.

In some aspects, imidizing the polyamic acid salt comprises thermally imidizing the corresponding polyamic acid. Irradiation of the wet gel polyamic acid material with microwave frequency energy is one particularly suitable thermal treatment.

In other aspects, imidizing the polyamic acid salt comprises performing chemical imidization, where chemical imidization comprises adding a gelation initiator to the aqueous solution of the salt of the polyamic acid to form a gelation mixture (a “sol”), and allowing the gelation mixture to gel (e.g., in molds, or cast on sheet, or in other various formats, such as beads). In such aspects, the gelation initiator is added to initiate and drive imidization, forming the polyimide wet gel from the polyamic acid salt.

The structure of the gelation initiator may vary but is generally a reagent that is at least partially soluble in the reaction solution, reactive with the carboxylate groups of the polyamic acid salt, and effective in driving the imidization of the polyamic acid carboxyl and amide groups, while having minimal reactivity with the aqueous solution. One example of a class of suitable gelation initiator is the carboxylic acid anhydrides, such as acetic anhydride, propionic anhydride, and the like. In some aspects, the gelation initiator is acetic anhydride.

In some aspects, the quantity of gelation initiator may vary based on the quantity of tetracarboxylic acid dianhydride or polyamic acid. For example, in some aspects, the gelation initiator is present in various molar ratios with the tetracarboxylic acid dianhydride. In some aspects, the gelation initiator is present in various molar ratios with the polyamic acid. The molar ratio of the gelation initiator to the tetracarboxylic acid dianhydride or polyamic acid may vary according to desired reaction time, reagent structure, and desired material properties. In some aspects, the molar ratio is from about 2 to about 10, such as from about 2, about 3, about 4, or about 5, to about 6, about 7, about 8, about 9, or about 10. In some aspects, the ratio is from about 2 to about 5.

The temperature at which the gelation reaction is allowed to proceed may vary, but is generally less than about 50° C., such as from about 10 to about 50° C., or from about 15 to about 25° C.

### 5. Other Polymer Organogels

In some aspects, the solid organogel comprises a melamine-aldehyde polymer. In some aspects, the solid organogel comprises a polyacrylamide polymer. In some aspects, the solid organogel comprises a polybenzoxazine polymer. Such polymers, precursors thereof, and appropriate gelation initiators for formation thereof are known to one of skill in the art.

### 6. Concentration of Organogel Precursor Materials

In some examples, the organogel precursor materials, collectively, are present in a concentration of the total mixture (i.e., including the lithium transition metal phosphate cathode material precursors) that approximates that of the carbon content of a resulting lithium metal phosphate material. For example, the organogel precursors may be present in approximately from 1% by weight (wt %) to 5 wt % of the stoichiometric amounts of lithium, transition metal, and phosphorous precursors in a 1:1:1 ratio.

### C. Mixing

The method comprises mixing for period of time the group of precursors for synthesizing the lithium transition metal phosphate and the one or more carbon precursors in a fluid state to form a precursor mixture, followed by adding the gelation initiator. The mixing is generally conducted by stirring the mixture (i.e., as a suspension) at room temperature (e.g., approximately 20° C.) for a period from about 1 to about 12 hours, and typically from about 2 to about 4 hours. During this time, the particle size of the transition metal oxide is generally reduced from the initial particle size to a particle size in a range from about 1 to about 3 microns. Depending on the initial particle size, it may in some aspects be desirable to perform an active particle size reduction, such as by milling, grinding, or the like. In other aspects, no such particle size reduction is performed beyond the described stirring. The mixture is generally allowed to mix (e.g., by stirring) for a period of time sufficient to allow complete dissolution of the lithium-ion source in the aqueous suspension.

### D. Solid Organogel

As described herein above, the method comprises forming a solid organogel by allowing the one or more organogel precursor materials to undergo gelation. The term “solid” as used herein in reference to the organogel means that the organogel is self-supporting, for example, a solid organogel is one which maintains a defined shape in the absence of any containment.

The solid organogel possesses a three-dimensional external (i.e., macro-) and internal (e.g., micro-, such as fibrils/pores) structure, whether it comprises a PF polymer, a polyamic acid, a polyimide, or another polymer as described herein. In some aspects, the solid organogel is a polyamic acid, a polyimide, or a combination thereof. For example, in certain aspects, a polyamic acid ammonium salt as described herein above, after gelation, is converted partially to the corresponding polyamic acid and partially to the corresponding polyimide. The relative proportion of polyamic acid and polyimide may vary. The proportion of each may be determined by methods known in the art, such as nuclear magnetic resonance (NMR) and Fourier Transform Infrared Spectroscopy (FTIR). Without wishing to be bound by theory, it is believed that a larger proportion of polyimide in the organic matrix results in a harder, solid lithium metal phosphate material embedded in the carbon matrix after pyrolysis. Further, surprisingly, according to the present disclosure, it has been discovered that the presence of relatively larger amounts of polyamic acid in the organic matrix, in at least some aspects, provides a lithium transition metal phosphate/carbon matrix product with fewer impurities, greater uniformity of particle size, a greater uniformity of morphology, or a combination thereof, relative to products obtained in the presence of relatively larger amounts of polyimide. These differences may be inferred by multiple observational techniques including, but not limited to, x-ray diffractometry, electron microscopy, and acoustic densitometry.

The solid organogel further comprises additional components present in the reaction mixture, such as lithium ions, transition metal oxide particles (e.g., iron (II or III) oxide), phosphate (PO₄³⁻) ions, and water suspended therein. At least a portion of the lithium ions and the phosphate ions may be associated as lithium phosphate. Generally, the various species present (lithium and phosphate ions or salts thereof, transition metal oxide, and water) are held together in close proximity within the organogel. Without wishing to be bound by any particular theory, it is believed that this close physical contact facilitates formation of the cathode material during pyrolysis, and advantageously provides desirable physical properties to the cathode material. As described herein above, the use of the organogel inhibits phase separation of the precursor materials during formation of the lithium transition metal phosphate cathode material. Because formation of cathode materials is a diffusion-limited process, maintaining intimate contact between the lithium transition metal phosphate precursor materials is particularly important for efficient and effective synthesis of the lithium transition metal phosphate cathode materials. The viscosity of the organogel, the reaction mixture comprising the organogel precursor materials, or both, may vary, and is generally selected such that at room temperature and atmospheric pressure, the viscosity of the organogel is sufficient to prevent settling of solid phase materials (including but not limited to the transition metal source, such as transition metal oxides and the liquid phase material(s)) from the reaction mixture due to density differences.

In some examples, the organogel precursor materials may gel nearly instantaneously (e.g., less than 30 seconds, less than 15 seconds, less than 5 seconds), thereby preventing phase separation of the other precursors (e.g., a solid phase having a density of greater than 1 gram/cm³ and a liquid phase having a density about 1 gram/cm³). In some examples, gelation occurs via the above-described polymerization reactions and not through removal of a solvent. This may reduce the energy inputs required to produce lithium iron phosphate cathode materials by avoiding or reducing the need for energy intensive drying processes. Notably, the solid aerogel produced by such gelation is different and distinct from other solid phase materials utilized in prior reported syntheses of LFP materials in a carbon matrix (e.g., sugars or starches, which do not gel).

Further, as described herein above, the precursors and conditions of gelation are selected such that the resulting organogel maintains the desired solid form, thereby maintaining intimate contact between the reactants during the thermal processing (pyrolysis) needed to convert the precursors to the lithium transition metal phosphate cathode material. In some aspects, the solid organogel comprises a porous network of interconnected solid phase polymer structures, and the porous network maintains contact between the first precursor of the group and the second precursor of the group, for example a transition metal species such as an iron oxide and a lithium/phosphate species (e.g., LiH₂PO₄). Notably, lithium phosphate (LiH₂PO₄) melts at above 300° C. Accordingly, in some aspects, the organogel maintains contact between the precursors to a temperature of at least about 300° C. Again this property of the disclosed organogels is different and distinct from other solid phase materials utilized in prior reported syntheses of LFP materials in a carbon matrix (e.g., sugars or starches, which do not maintain structural rigidity when heated).

### E. Pyrolyzing

The solid organogel comprising the lithium transition metal phosphate precursor materials (e.g., lithium ions, one or more transition metal oxides, and phosphate ions) is then pyrolyzed (e.g., carbonized), meaning the organogel is heated at a temperature and for a time sufficient to 1) convert substantially all of the organogel material into carbon, forming a conductive carbon matrix; 2) optionally, reduce higher oxidation state transition metal to a lower state (e.g., reduction of Fe(III) as in Fe₂O₃ to the Fe(II) required in LiFePO₄); and 3) form the lithium transition metal phosphate cathode material, which is included within the conductive carbon matrix. As used herein in the context of pyrolysis, “substantially all” means that greater than 95% of the organogel material is converted to carbon, such as 99%, or 99.9%, or 99.99%, or even 100% of the organogel is converted to carbon. Pyrolyzing the organogel converts the organogel to an isomorphic carbon matrix, meaning the physical properties (e.g., porosity, surface area, pore size, diameter, and the like) of the organogel are substantially retained in the corresponding carbon matrix. Without wishing to be bound by theory, it is believed that the carbonization helps promote good electrical conductivity of the resulting matrix, and at the same time initiates and drives to completion the reaction between the transition metal oxide, lithium ions, and phosphate ions to form the lithium-transition metal-phosphate cathode material within the conductive carbon matrix. Further, the organogel materials disclosed herein are rich in aromatic rings, which, upon pyrolysis, results in a carbon matrix with high conductivity. Even further, the even distribution of the lithium-transition metal-phosphate cathode material throughout the continuous, three-dimensional conductive carbon matrix provides superior performance properties of batteries utilizing such cathode materials as described further herein below.

Without wishing to be bound by theory, it is believed that during the pyrolysis, the lithium-transition metal-phosphate cathode material inherits the form of the precursor transition metal oxide, forming on top of the transition metal oxide by a templating process. This is believed to be different and distinct from previously reported processes for forming LiFePO₄, in which water is evaporated from a slurry and loose precursor ions associate during the evaporation.

In aspects where the transition metal of the transition metal oxide is present in a higher oxidation state than is present in the lithium-transition metal-phosphate cathode material, as described herein above, it is believed that a portion of the carbon generated during the pyrolysis serves to reduce the oxidation state of the transition metal (e.g., from iron (III), present in, e.g. Fe₂O₃, to iron (II)).

The temperature required for pyrolyzing may vary. In some aspects, the organogel matrix is subjected to a treatment temperature of about 600° C. or above, such as about 600° C., about 650° C. about 700° C., about 750° C., about 800° C., about 850° C., about 900° C., or about 950° C., or in a range between any two of these values, to carbonize the organogel matrix and complete formation of the lithium-transition metal-phosphate cathode material. In some aspects, the pyrolysis temperature is from about 600 to about 800° C. Generally, the pyrolysis is conducted under an inert or slightly reducing atmosphere to prevent combustion of the organic and/or carbon material and prevent reoxidation of the transition metal. Suitable atmospheres include, but are not limited to, nitrogen, argon, hydrogen, methane, or combinations thereof. In some aspects, pyrolysis is performed under nitrogen.

In some aspects, the pyrolysis is performed using microwave irradiation. A microwave is a low energy electromagnetic wave with a wavelength in the range of 0.001-0.3 meters and a frequency in the range of 1,000-300,000 MHz. Typical microwave devices operate with microwaves at a frequency of 2450 MHz. In some aspects, the group of precursors includes a precursor having microwave susceptibility and the pyrolyzing is performed by applying microwave radiation.

In some aspects, the precursor having microwave susceptibility comprises one or more of carbon, magnetite, and maghemite. In some aspects, the precursor comprises magnetic iron oxide nanoparticles (magnetic IONP), such as nanoparticulate magnetite or maghemite. In some aspects, the precursor having microwave susceptibility comprises nanoparticles of one or more of magnetite and maghemite having a characteristic dimension of from 20 nm to 100 nm.

In some aspects, as magnetic IONP is progressively converted to LiFe(PO₄) and the organogel precursor is pyrolyzed into carbon, the microwave absorbing component changes from the magnetic phase to the carbonized component. This is because LiFe(PO₄) itself does not respond to microwave radiation strongly, but carbon materials do heat efficiently upon exposure to microwave radiation as described herein above.

The time required for completion of the pyrolyzing may vary, and may depend on the temperature and the particular matrix components. Generally, the matrix is subjected to the pyrolysis condition for a period of time in a range from about 4 to about 20 hours, such as about 8 hours. In some examples, microwave pyrolysis may be more energy efficient and faster, using a period of time that is from about 10 minutes to about 3 hours, such as from about 10 minutes to about 1 hour, or from about 1 hour to about 3 hours.

Another benefit of the disclosed method is that the carbon sources (e.g., organogel such as a polyamic acid or polyimide) have a high carbon yield; therefore, relatively low weight percentages (˜ 20 wt %) of the carbon source are needed relative to the entire reactant composition, leading to high efficiency and cost savings. Particularly, the small amount of carbon source, during pyrolysis, is sufficient to reduce all higher oxidation state transition metal species (e.g., Fe(III) to Fe(II) in the case of the ferric oxide precursors) and leave about 2-3% of conductive carbon at the surface of the lithium-transition metal phosphate.

Further, the carbon sources disclosed herein (e.g., organogels such as polyamic acids, polyimides, and the other polymers described above) comprise an abundance of aromatic rings. During pyrolysis, these materials therefore produce graphitic carbon coatings of the lithium-transition metal phosphates. The graphitic carbon produced upon carbonization of these materials provides better electrical characteristics (e.g., higher conductivities) than the saturated carbons found from carbonization of other carbon sources, such as sugar or starches.

### F. Milling

In some aspects, the lithium-transition metal-phosphate cathode material within the conductive carbon matrix is optionally subjected to one or more milling procedures to reduce particle size or provide an even distribution of particle sizes. Any suitable milling technique may be utilized. In some aspects, milling may be performed using a ball mill. In some aspects, the milling is performed in a stainless steel planetary ball mill at a speed in a range from about 100 to 400 rpm, and for a time in a range from about 30 minutes to about 48 hours.

The need for milling, the type of milling, and the duration thereof may vary based on the nature of the conductive carbon matrix. For example, in some aspects, cathode material particles prepared from pyrolysis of polyimide organogels have a hard carbon matrix and may require milling to provide powder materials (i.e., having a uniformly small particle size). In contrast, the cathode material particles prepared from pyrolysis of polyamic acid organogels tend to be softer and may require relatively less milling.

### II. Lithium Transition Metal Phosphate Cathode Material Properties

Following the pyrolysis, the lithium-transition metal-phosphate cathode material within the conductive carbon matrix has a formula LiM(PO₄), where M is iron (Fe), manganese (Mn) or a combination of Fe and Mn; or the lithium-transition metal-phosphate cathode material within the conductive carbon matrix has a formula Li₃M (PO₄)₃, where M is vanadium (V). In aspects where M is a combination of Fe and Mn, the stoichiometry of Fe to Mn may vary. For example, the molar ratio of Fe to Mn may be in a range from about 0.1 to about 10, such as about 0.1, about 0.2, about 0.3, about 0.4, about 0.5, about 0.6, about 0.7, about 0.8, about 0.9, or about 1, to about 2, about 3, about 4, about 5, about 6, about 7, about 8, about 9, or about 10. In some aspects, the molar ratio of Fe to Mn is from about 4:1 to about 1:4, from about 2:1 to about 1:2, or about 1:1.

In some aspects, the lithium-transition metal-phosphate cathode material within the conductive carbon matrix has a formula LiM (PO₄), where M is iron (Fe), manganese (Mn) or a combination of Fe and Mn, and the source of the transition metal oxide utilized in the method comprises magnetite, maghemite, or a combination thereof. In some such aspects, a residual quantity of magnetite, maghemite, or a combination thereof may remain present in the lithium-transition metal-phosphate cathode material within the conductive carbon matrix. The residual quantity may vary but is generally present in an amount sufficient to impart magnetic susceptibility to the cathode material. The magnetic susceptibility imparted by the residual magnetic iron oxide material may vary, but is generally weak, though sufficient to be observed at least qualitatively through interactions of a sample of the lithium-transition metal-phosphate cathode material within the conductive carbon matrix with a strong neodymium magnet. Quantitative measurements may be performed according to known methods for susceptibility measurements, including, but not limited to a Gouy balance (where a sample is hung between the poles of an electromagnet, and the change in weight when the electromagnet is turned on is proportional to the susceptibility) and an Evans balance (which measures the force on the magnet itself).

In some aspects, the lithium-transition metal-phosphate cathode material within the conductive carbon matrix, when prepared from magnetite, maghemite, or a combination thereof, has a tap density in a range from about 0.6 to about 1.1 g/cm³.

In some aspects, the lithium-transition metal-phosphate cathode material is an olivine lithium iron phosphate. Accordingly, in another aspect is provided a composition comprising a nanoparticle comprising olivine lithium iron phosphate and integral with a conductive carbon matrix, wherein the nanoparticle has a characteristic dimension from 20 nm to 1000 nm, and a specific surface area from 10 meters² (m²)/gram (g) to 65 m²/g. In some aspects, the characteristic dimension is from 30 nm to 70 nm and the specific surface area is from 20 m²/g to 65 m²/g. In some aspects the characteristic dimension is from 30 nm to 60 nm and the specific surface area is from 22 m²/g to 40 m²/g. In some aspects, the characteristic dimension is from 20 nm to 40 nm and the specific surface area is from 60 m²/g to 80 m²/g.

In some aspects, the nanoparticle further comprises magnetite, maghemite, or both.

In some aspects, the nanoparticle further comprises manganese.

In some aspects, the conductive carbon matrix comprises a carbonized organogel as described herein.

### III. Method of Forming Lithium Vanadium Fluorophosphate Cathode Materials Within a Conductive Carbon Matrix; Fluorophosphate Ions

In another aspect of the disclosure is provided a method of preparing a lithium vanadium fluorophosphate cathode material within a conductive carbon matrix. The method is substantially similar to that for forming a lithium transition metal phosphate cathode material as described herein above, with the exception of replacement of phosphoric acid with a source of fluorophosphate ions (FPO₄²⁻), and selection of a vanadium, oxide as the transition metal oxide. Each of the mixing, source of lithium ions, organogel precursor materials, the gelation, the solid organogel, and the pyrolysis thereof are as described herein above.

The vanadium oxide may be any readily available oxide of vanadium, such as vanadium (III) oxide (V₂O₃), vanadium (IV) oxide (VO₂), vanadium (V) oxide (V₂O₅), or ammonium metavanadatc (NH₄VO₃).

The source of fluorophosphate ions may vary. For example, fluorophosphoric acid, or a fluorophosphate salt, such as sodium or ammonium monofluorophosphate, may be utilized to provide fluorophosphate ions. Alternatively, fluorophosphate ions may be formed in situ from the lithium-ion source, a phosphate ion source, and a fluoride ion source. The sources of lithium, phosphate, and a fluoride may be individual, or may be provided in various combinations. For example, the method may utilize a lithium source as described herein above, along with separate source of fluoride and phosphate, such as hydrofluoric acid or ammonium fluoride, and either phosphoric acid or an alkali metal or ammonium salt of phosphoric acid. Alternatively, the method may utilize a combined source of lithium and fluoride, such as lithium fluoride. One of skill in the art will recognize the various combinations of lithium, fluoride, and phosphate which may be utilized to provide lithium and fluorophosphates ions in the reaction mixture, and all such combinations are contemplated herein. The order of addition of any such components (lithium-ion source, fluoride ion and phosphate ion source, fluorophosphates source, or the like) may vary, and may be sequential or may be simultaneous.

Following the pyrolysis, the lithium vanadium fluorophosphate cathode material within the conductive carbon matrix has a formula LiVFPO₄. The resulting cathode materials may optionally be milled as described above with respect to lithium transition metal phosphate materials.

### IV. Method of Forming Lithium Vanadium Fluorophosphate Cathode Materials Within a Conductive Carbon Matrix; Fluoropolymer as F-source

In another aspect of the disclosure is provided an alternative method of preparing a lithium vanadium fluorophosphate cathode material within a conductive carbon matrix. The method is substantially similar to that for forming a lithium vanadium fluorophosphate cathode material as described herein above, with the exception of replacement of the source of fluorophosphate ions with phosphoric acid and providing fluoride in the form of a fluoropolymer. Each of the mixing, source of lithium ions, organogel precursor materials, the gelation, the solid organogel, and the pyrolysis thereof are as described herein above. The method further adding a fluoropolymer to the precursor mixture prior to gelation.

The vanadium oxide may be any readily available oxide of vanadium, such as vanadium (III) oxide (V₂O₃), vanadium (IV) oxide (VO₂), vanadium (V) oxide (V₂O₅), or ammonium metavanadate (NH₄VO₁).

Examples of suitable fluoropolymers include, but are not limited to, polytetrafluorocthylene, polyvinylidene difluoride, and combinations thereof. Without wishing to be bound by theory, it is believed that such fluoropolymers are physically incorporated into the organogel matrix (e.g., as a physical combination) rather than chemically integrated into the organogel polymer, and during subsequent pyrolysis, the fluoropolymer decomposes and liberates fluorine species which react with phosphate ions to form fluorophosphates in situ, and/or react directly with the vanadium oxide species, forming intermediate of final species in which fluorine is coordinated with vanadium. Such an alternative method addresses a potential issue with employing fluorophosphates sources such as fluorophosphoric acid (H₂FPO₃). Specifically, fluorophosphoric acid gradually hydrolyzes to H₃PO₄ and hydrogen fluoride (HF). The HF is volatile and toxic, and can escape the reaction mixture upon drying, making it difficult to maintain the requisite 1:1:1:1 lithium:vanadium:phosphate:fluorine stoichiometry.

The method disclosed herein using a fluoropolymer avoids the liabilities of using fluorophosphoric acid.

### V. Method of Forming Lithium Vanadium Fluorophosphate Cathode Materials Within a Conductive Carbon Matrix; Fluoromonomer

In another aspect of the disclosure is provided a further alternative method of preparing a lithium vanadium fluorophosphate cathode material within a conductive carbon matrix. The method is substantially similar to that for forming the lithium vanadium fluorophosphate cathode materials using a fluoropolymer as described herein above, with the exception that the fluoropolymer is replaced with a fluorinated monomer which co-polymerizes with the organogel precursor materials to form an organogel in which at least a portion of the hydrogen atom substituents are replaced with fluorine atoms.

Similar to the method for preparing a lithium vanadium fluorophosphate cathode material within a conductive carbon matrix using a fluoropolymer as disclosed above, this alternative method employs a fluorinated monomer which is chemically incorporated into the organogel polymer. By “at least a portion of the one or more organogel precursor materials comprise a fluorinated monomer” is meant that some amount of the one or more organogel precursor material are fluorinated. The amount of fluorinated monomer present as an organogel precursor material may vary from, for example, about 1% to about 100% of the total amount of organogel precursor material utilized. Further, the extent of fluorination (i.e., the number of fluorine substituents present on a given organogel precursor monomer structure) within said monomer may vary. In some aspects, the organogel is a polymide, and some portion of the polyimide organogel precursor materials (e.g., a diamine and a tetracarboxylic dianhydride, or polyamic acid) bear one or more fluorine substituents. In some aspects, the polymide is formed in situ from organogel precursor materials which are a phenylenediamine and a tetracarboxylic dianhydride, and the phenylenediamine, the tetracarboxylic dianhydride, or both bear one or more fluorine substituents. In particular aspects, the fluorinated monomer is 1,4-phenylenediamine bearing one or more fluorine atoms, for example, 2,3,5,6-tetrafluorobenzene-1,4-diamine. Again, utilizing organogel precursor materials bearing fluoro substituents as the fluoride source avoids the loss of volatile and toxic HF gas during the early stages of solvent evaporation and the initial drying.

### VI. Energy Storage Systems

In another aspect of the disclosure is provided an energy storage system comprising a lithium transition metal phosphate cathode material as described herein. In another aspect of the disclosure is provided an energy storage system comprising a composition comprising a nanoparticle comprising olivine lithium iron phosphate and integral with a conductive carbon matrix, wherein the nanoparticle has a characteristic dimension from 20 nm to 1000 nm, and a specific surface area from 10 meters² (m²)/gram (g) to 65 m²/g.

Examples of energy storage systems include batteries, such as lithium-ion batteries, comprising the composition or cathode material as described herein. Further disclosed herein are battery cells, battery modules, battery packs, electronic devices, and electric vehicles comprising the composition or cathode material as described herein.

In this application, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent. Protection may be sought for any features disclosed in any one or more published documents referenced herein in combination with the present disclosure. All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed. No language in the specification should be construed as indicating any non-claimed element as essential to the practice of the disclosed materials and methods.

It will be readily apparent to one of ordinary skill in the relevant arts that suitable modifications and adaptations to the compositions, methods, and applications described herein can be made without departing from the scope of any aspects or aspects thereof. The compositions and methods provided are exemplary and are not intended to limit the scope of the claimed aspects. All of the various aspects and options disclosed herein can be combined in all variations. The scope of the compositions, formulations, methods, and processes described herein include all actual or potential combinations of aspects, options, examples, and preferences herein.

Although the technology herein has been described with reference to particular aspects, it is to be understood that these aspects are merely illustrative of the principles and applications of the present technology. It will be apparent to those skilled in the art that various modifications and variations can be made to the method and apparatus of the present technology without departing from the spirit and scope of the technology. Thus, it is intended that the present technology include modifications and variations that are within the scope of the appended claims and their equivalents.

Reference throughout this specification to “one aspect,” “certain aspects,” “one or more aspects” or “an aspect” means that a particular feature, structure, material, or characteristic described in connection with the aspect is included in at least one aspect of the technology. Thus, the appearances of phrases such as “in one or more aspects,” “in certain aspects,” “in one aspect” or “in an aspect” in various places throughout this specification are not necessarily referring to the same aspect of the technology. Furthermore, the particular features, structures, materials, or characteristics may be combined in any suitable manner in one or more aspects. The invention may also broadly consist in the parts, elements, steps, examples and/or features referred to or indicated in the specification individually or collectively in any and all combinations of two or more said parts, elements, steps, examples and/or features. In particular, one or more features in any of the aspects, examples and aspects described herein may be combined with one or more features from any other examples and aspects described herein.

Aspects of the present technology are more fully illustrated with reference to the following examples. Before describing several exemplary aspects of the technology, it is to be understood that the technology is not limited to the details of construction or process steps set forth in the following description. The technology is capable of other aspects and of being practiced or being carried out in various ways.

Further modifications and alternative aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of aspects. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

Although certain example aspects of the invention have been described, the scope of the appended claims is not intended to be limited solely to these aspects. The claims are to be construed literally, purposively, and/or to encompass equivalents.

The following examples are set forth to illustrate certain aspects of the present technology and are not to be construed as limiting thereof.

### EXAMPLES

The present invention may be further illustrated by the following non-limiting examples describing the methods.

### Example 1: Synthesis of Lithium Iron Phosphate in Carbon Matrix (Fe₂O₃/Phloroglucinol/Furfuraldehyde)

A sample of lithium iron phosphate in a carbon matrix was prepared using iron (III) oxide (Fe₂O₃) as the iron source and phloroglucinol-furfuraldehyde polymer as the carbon source. The iron (III) oxide (2.8 g, 13 mmol; particle size of 5 microns or less) was added to deionized water (10 ml) and the suspension stirred for 5 minutes at room temperature. Phosphoric acid (85% H₃PO₄; 2 ml, 26 mmol) was added, and the suspension stirred for 2 hours. Lithium carbonate (Li₂CO₃; 0.96 g, 13 mmol) was added and the resulting suspension was stirred until evolution of carbon dioxide ceased. In a separate container, phloroglucinol (1.68 g) was dissolved in 10 m¹ of ethanol. Furfuraldehyde (1.68 ml) was added to the phloroglucinol solution, and the solution mixed for 5 min. After the mixing, the solution was added in one portion to the iron oxide/lithium/phosphate suspension. The suspension was stirred overnight at room temperature, resulting in a viscous mixture. The solvent (ethanol and water) was evaporated by stirring at 100° C. A uniform, dry powder was obtained, which was pyrolyzed under nitrogen using the temperature gradients provided in Table 2 to provide powdered lithium iron phosphate in a carbon matrix.

TABLE 2
Pyrolysis protocol

| Condition | Time |
|---|---|
| Heat with 5° C. per minute | 155 minutes |
| ramp to 800° C. | |
| Hold at 800° C. | 480 minutes |
| Cool with 1° C. per minute | 775 minutes |
| ramp to room temperature | |

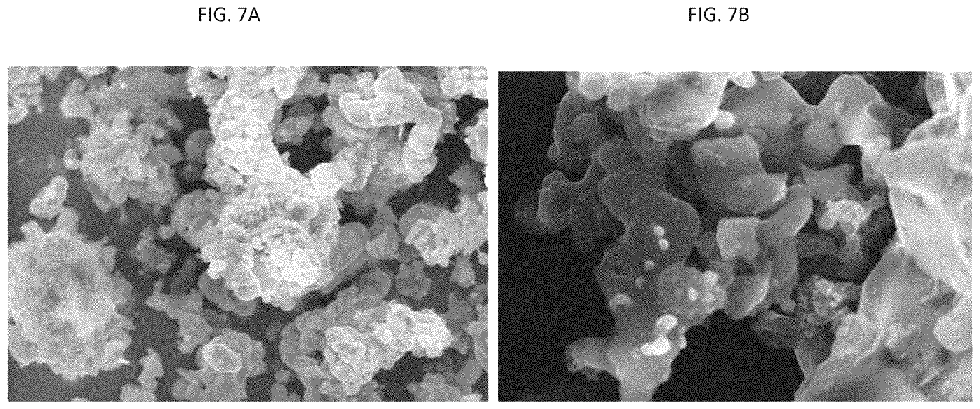

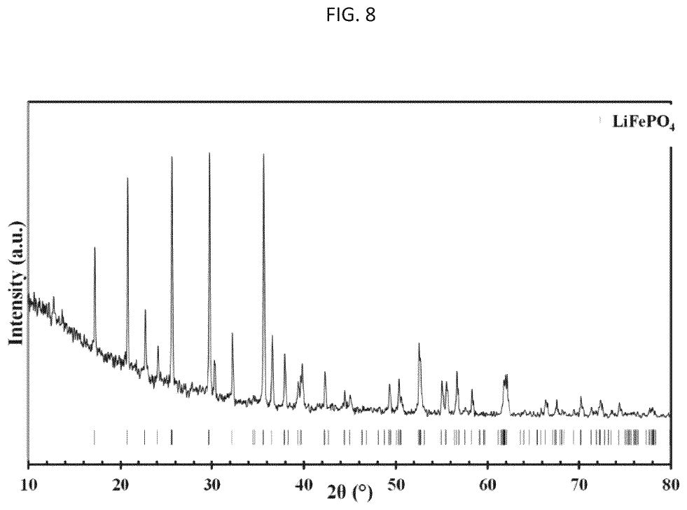

A sample of the powdered lithium iron phosphate in a carbon matrix was analyzed by scanning electron microscopy. Photomicrographs for two magnifications (1,490× and 5,050×) are provided as FIGS. 7A and 7B respectively. With reference to FIGS. 7A and 7B, lithium iron phosphate formed as primary particles of sub-micron to several microns in size. The primary particles are aggregated into secondary particles of several tens of microns in diameter and connected to each other via the carbon matrix. A sample was also subjected to powder X-ray diffraction (XRD) analysis, which demonstrated that the major phase of the material was olivine-type LiFePO₄, with a minor phase comprising unidentified impurities (FIG. 8).

### Example 2: Synthesis of Lithium Iron Phosphate in Carbon Matrix Fe(OH)₃/Phloroglucinol/Furfuraldehyde)

A sample of lithium iron phosphate in a carbon matrix was prepared using iron (III) hydroxide (Fe(OH)₃) as the iron source and phloroglucinol-furfuraldehyde polymer as the carbon source. The iron (III) hydroxide was prepared by dissolving iron (III) nitrate hydrate (Fe(NO₃)-3.9H₂O; 3.50 g; 8.7 mmol) in deionized water (30 ml). To this solution was added a solution of sodium hydroxide (2.1 g; 52.5 mmol) in deionized water (15 ml), resulting in instantaneous formation of an aqueous suspension of iron (III) hydroxide gel. The iron hydroxide gel was aged in the mother solution overnight, then separated and purified by cycles of centrifugation and resuspension in deionized water (5 cycles in total). Phosphoric acid (85% H₃PO₄; 0.7 ml, 8.7 mmol) was added, followed by lithium carbonate (Li₂CO₃; 0.32 g, 4.3 mmol) and the resulting suspension was stirred until evolution of carbon dioxide ceased. In a separate container, phloroglucinol (1.05 g) was dissolved in 4 m¹ of ethanol. Furfuraldehyde (0.57 ml) was added to the phloroglucinol solution and the solution mixed for 5 min. After the mixing, the solution was added in one portion to the iron hydroxide/lithium/phosphate suspension. The suspension was stirred overnight at room temperature, resulting in a viscous mixture. The solvent (ethanol and water) was evaporated by stirring at 100° C. A uniform, dry powder was obtained, which was pyrolyzed under nitrogen using the protocol described in Example 1 to provide lithium iron phosphate in a carbon matrix.

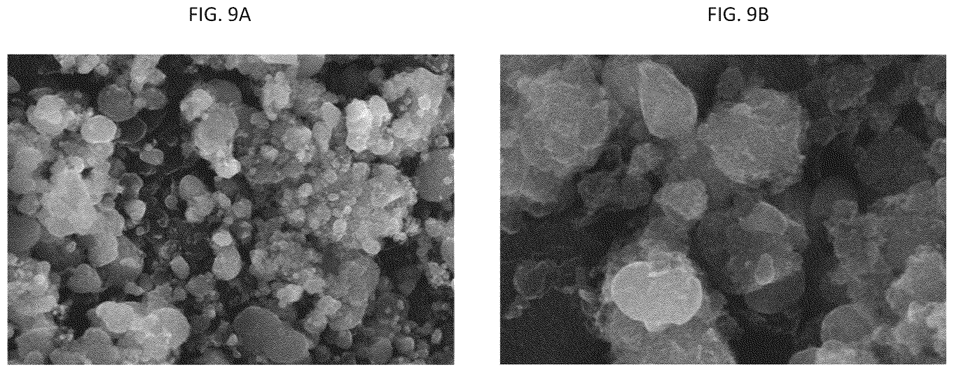

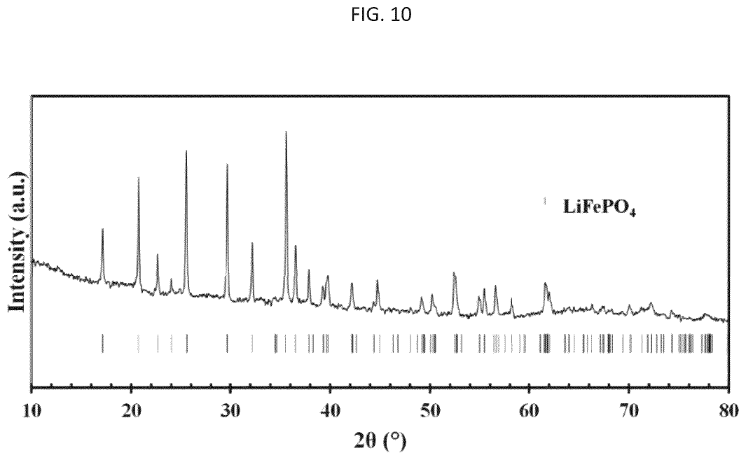

A sample of the powdered lithium iron phosphate in a carbon matrix was analyzed by scanning electron microscopy. Photomicrographs at two magnifications (10,000× and 49,900) are provided as FIGS. 9A and 9B, respectively. With reference to FIGS. 9A and 9B, the LFP formed as fine crystallites of about 100 nm to about 1 micron diameter, dispersed uniformly in the conductive carbon network. The aggregate of secondary particles varies in size from about 1 micron to several microns with an open framework structure through which electrolyte can penetrate. A sample was also subjected to powder X-ray diffraction (XRD) analysis, which demonstrated that the major phase of the material was olivine-type LiFePO₄, with a minor phase comprising approximately 2% iron (FIG. 10). The iron impurity phase can be separated magnetically or may be exploited as a ferromagnetic agent that increases the packing density of the particles in a cathode film during e.g., magnetic electrode film casting.

### Example 3: Synthesis of Lithium Iron Phosphate in Carbon Matrix (Fe(OH)₃/Phloroglucinol/Furfuraldehyde)

A second sample of lithium iron phosphate in a carbon matrix was prepared according to the procedure of Example 2 but using double the ratio of PF precursors to LFP precursors in order to evaluate the effect of the residual carbon on particle size distribution and impurity profile.

A sample of the powdered lithium iron phosphate in a carbon matrix was analyzed by scanning electron microscopy at two magnifications (10,000× and 100,000×).

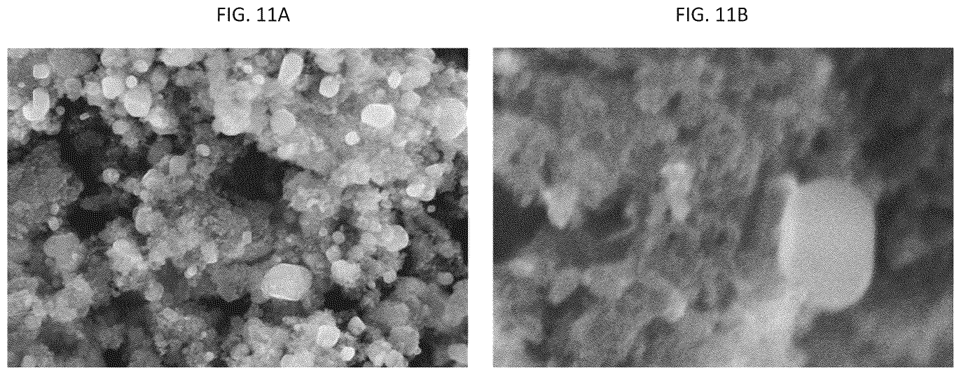

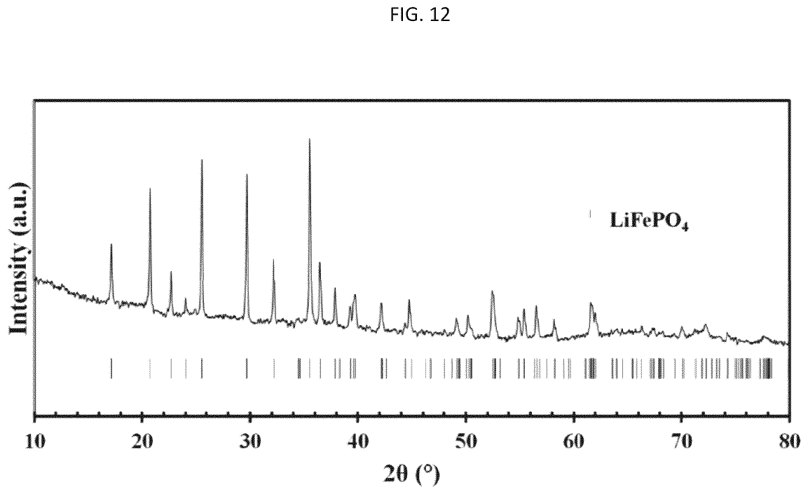

Photomicrographs for each magnification are provided as FIGS. 11A and 11B respectively. With reference to FIGS. 11A and 11B, the LFP formed as fine crystallites of about 100 nm to about 1 micron diameter, dispersed uniformly in the conductive carbon network. The aggregate of secondary particles varies in size from about 1 micron to several microns with an open framework structure through which electrolyte can penetrate. A sample was also subjected to powder X-ray diffraction (XRD) analysis, which demonstrated that the major phase of the material was olivine-type LiFePO₄, with a minor phase comprising approximately 3% iron (FIG. 12). The iron impurity phase can be separated magnetically or may be exploited as a ferromagnetic agent that increases the packing density of the particles in a cathode film during e.g., magnetic electrode film casting.

### Example 4: Synthesis of Lithium Iron Phosphate in Carbon Matrix (Fe₂O₃/Pyromellitic Dianhydride/1,4-Phenylene Diamine; PAA/Low PI Gel)

A sample of lithium iron phosphate in a carbon matrix was prepared using iron (III) oxide (Fe₂O₃) as the iron source and a polyimide gel as the carbon source. The iron (III) oxide (10.38 g, 65 mmol) was added to deionized water (50 ml) and the suspension stirred for 5 minutes at room temperature. Phosphoric acid (85% H₃PO₄; 10 ml, 130 mmol) was added, and the suspension stirred for 2 hours. Lithium carbonate (Li₂CO₃; 5.05 g, 68.2 mmol) was added and the resulting suspension was stirred until evolution of carbon dioxide ceased. In a separate container, 1,4-pheneylene diamine (PDA; 2.0 g), pyromellitic dianhydride (PMDA; 6.8 g), and triethylamine (9.3 ml) were added to deionized water (100 ml). The mixture was allowed to react overnight to form a polyamic acid triethylammonium salt solution. To this solution was added acetic anhydride (11.3 ml) to initiate imidization. After mixing for 1 minute, the gelation solution was added in one portion to the iron suspension. The resulting reaction mixture was loosely capped and heated with stirring at 100° C. for 24 hours. During this time, the solvent evaporated, and a uniform, dry powder was obtained. The organic matrix comprised a mixture of polyimide and polyamic acid enriched in the polyamic acid. This dry powder was pyrolyzed using the protocol described in Example 1 to provide lithium iron phosphate in a carbon matrix.

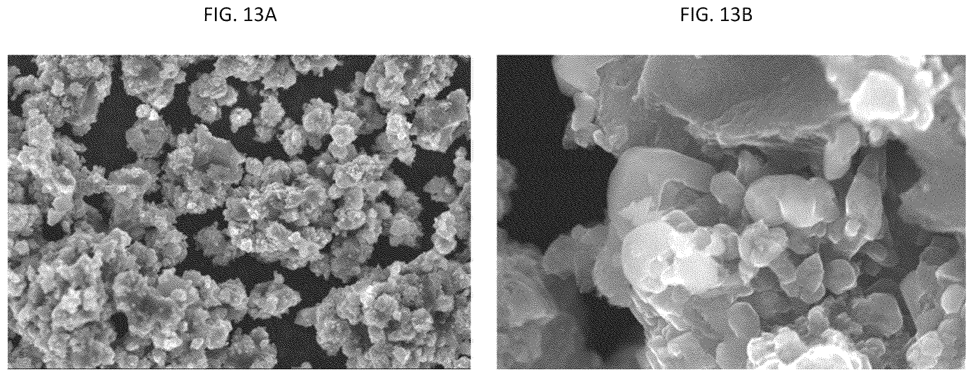

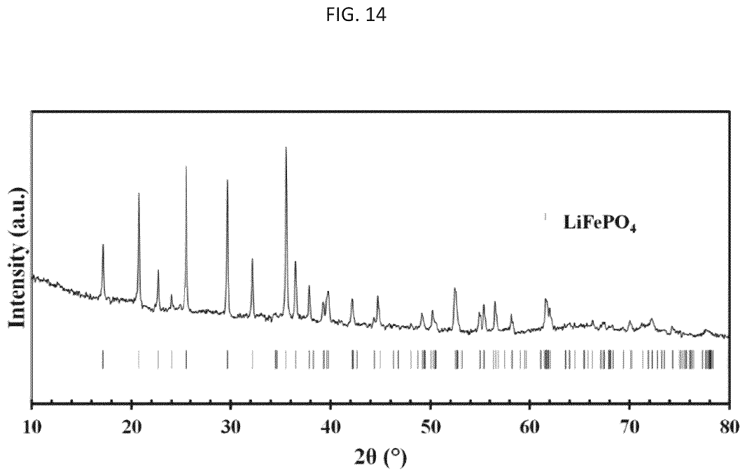

A sample of the powdered lithium iron phosphate in a carbon matrix was analyzed by scanning electron microscopy. Photomicrographs at two magnifications (2,000× and 20,000×) are provided as FIGS. 13A and 13B, respectively. With reference to FIGS. 13A and 13B, the LFP formed as an aggregate of submicron primary particles held together by the conductive carbon network into secondary particles of approximately 10 microns in diameter. A sample was also subjected to powder X-ray diffraction (XRD) analysis, which demonstrated that the major phase of the material was olivine-type LiFePO₄, with a minor phase comprising unidentified impurities (FIG. 14).

### Example 5: Synthesis of Lithium Iron Phosphate in Carbon Matrix (Fe₂O₃/Pyromellitic Dianhydride/1,4-Phenylene Diamine; PAA/Low PI Gel)

A sample of lithium iron phosphate in a carbon matrix was prepared using iron (III) oxide (Fe₂O₃) as the iron source and a polyamic acid gel as the carbon source. The iron (III) oxide (10.38 g, 65 mmol) was added to deionized water (50 ml) and the suspension stirred for 5 minutes at room temperature. Phosphoric acid (85% H₃PO₄; 10 ml, 130 mmol) was added, and the suspension stirred for 2 hours. Lithium carbonate (Li₂CO₃; 5.05 g, 68.2 mmol) was added and the resulting suspension was stirred until evolution of carbon dioxide ceased. In a separate container, 1,4-phencylene diamine (PDA; 2.0 g), pyromellitic dianhydride (PMDA; 6.8 g), and triethylamine (9.3 ml) were added to deionized water (100 ml). The mixture was allowed to react overnight to form a polyamic acid triethylammonium salt solution. The gel precursor mixture was then added to the iron oxide suspension, followed immediately by addition of acetic anhydride (11.3 ml). The resulting reaction mixture was loosely capped and heated with stirring at 100° C. for 24 hours. During this time, the solvent evaporated, and a uniform, dry powder was obtained. The organic matrix comprised predominantly polyamic acid with a minor amount of polyimide. Without wishing to be bound by theory, it is believed that the acidic environment resulted in hydrolysis of the acetic anhydride to acetic acid and gelation of the insoluble polyamic acid with minimal imidization occurring. This dry powder was pyrolyzed using the protocol described in Example 1 to provide lithium iron phosphate in a carbon matrix.

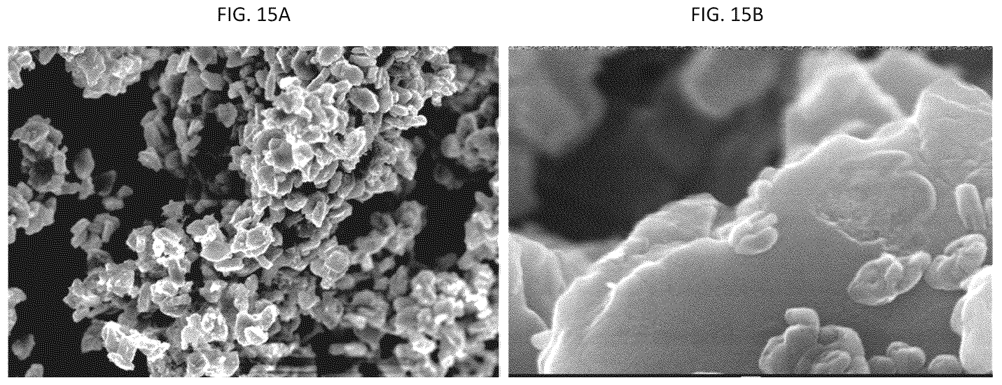

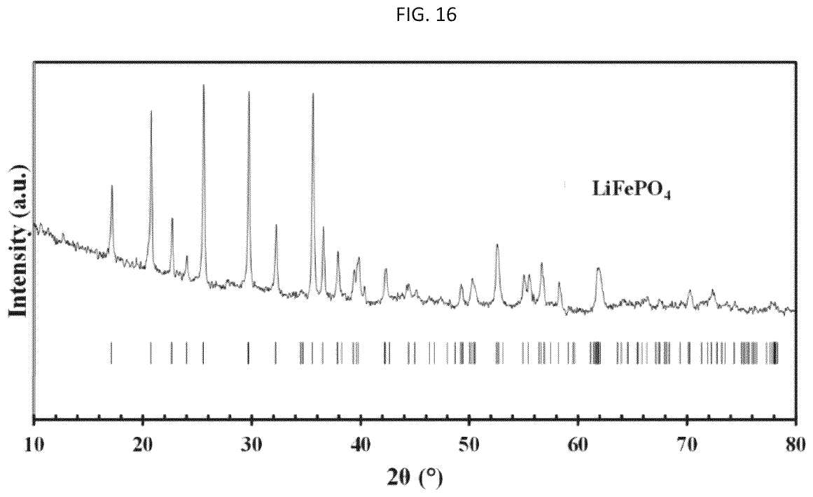

A sample of the powdered lithium iron phosphate in a carbon matrix was analyzed by scanning electron microscopy. Photomicrographs at two magnifications (2,000× and 50,000×) are provided as FIGS. 15A and 15B, respectively. With reference to FIGS. 15A and 15B, the LFP formed as an aggregate of uniform 2-micron primary particles that are assembled into 10-micron secondary particles within a porous network through which the electrolyte can penetrate. A sample was also subjected to powder X-ray diffraction (XRD) analysis, which demonstrated that the major phase of the material was olivine-type LiFePO₄, with a minor phase comprising unidentified impurities (FIG. 16).

### Example 6: Synthesis of Lithium Iron Phosphate in Carbon Matrix (Fe₂O₃/Pyromellitic Dianhydride/1,4-Phenylene Diamine; PAA/Moderate PI Gel)

A sample of lithium iron phosphate in a carbon matrix was prepared using iron (III) oxide (Fe₂O₃) as the iron source and a polyamic acid gel as the carbon source. The iron (III) oxide (10.38 g, 65 mmol) was added to deionized water (50 ml) and the suspension stirred for 5 minutes at room temperature. Phosphoric acid (85% H₃PO₄; 10 ml, 130 mmol) was added, and the suspension stirred for 2 hours. Lithium carbonate (Li₂CO₃; 5.05 g, 68.2 mmol) was added and the resulting suspension was stirred until evolution of carbon dioxide ceased. In a separate container, 1,4-phencylenediamine (PDA; 2.0 g), pyromellitic dianhydride (PMDA; 6.8 g), and triethylamine (9.3 ml) were added to deionized water (100 ml). The mixture was allowed to react overnight to form a polyamic acid triethylammonium salt solution. Tricthylamine (approximately 20 mL) was added to the iron oxide suspension, raising the pH to about 8.0 (from an initial 4.0). Then, the gel precursor solution was added all at once into suspension the iron oxide suspension, followed by acetic anhydride (11.3 mL) to initiate chemical imidization. The resulting reaction mixture was loosely capped and heated with stirring at 100° C. for 24 hours. During this time, the solvent evaporated, and a uniform, dry powder was obtained. The organic matrix comprised predominantly polyamic acid along with some polyimide. Without wishing to be bound by theory, it is believed that the relatively neutral environment resulted in an increase in the imidization/gelation of the polyamic acid salt relative to Examples 4 and 5. This dry powder was pyrolyzed using the protocol described in Example 1 to provide lithium iron phosphate in a carbon matrix.

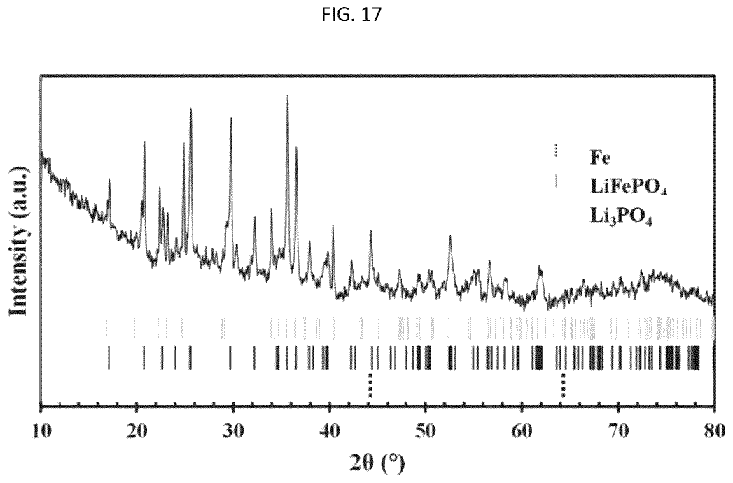

A sample of the product was subjected to powder X-ray diffraction (XRD) analysis, which demonstrated that the material is a mixture of LiFePO₄ (<70% wt.), unreacted Li₃PO₄ (˜30% wt.) with the balance being Fe (FIG. 17). This example surprisingly indicates that with a higher PI/PAA ratio in the organogel, significant portions of unreacted reagents are present in the final product. Without wishing to be bound by theory, it is believed that the rigid polyimide gel leads to less efficient contact between the LFP precursors, resulting in poor homogeneity of the reaction and a low product yield.

### Example 7: Raman Spectroscopy of Carbon Matrix

The electronic structures of the in situ formed carbons of Examples 1-7 are evaluated by Raman spectroscopy. Without wishing to be bound by theory, it is believed that the carbon matrix formed according to the disclosed methods may be more conductive than particulate carbon added to lithium metal phosphate cathode materials.

### Example 8: Analysis of Carbon Nanostructure

The nanostructure of the carbon matrix of the cathode materials formed in Examples 1-7 is evaluated by dissolving the lithium metal phosphate away from the carbon matrix. The remaining carbon material is analyzed to determine porosity, pore size, and carbon strut size. Specifically, skeletal density is determined by He pycnometry, and surface and pore structure via N₂ sorption isotherms. SEM, TEM, Raman, and X-ray scattering are performed for mid to long-range microstructure analysis. Elemental analysis for CHN is also performed.

1-32. (canceled)

33. A method of preparing a lithium transition metal phosphate cathode material within a conductive carbon matrix, the method comprising:
combining a group of precursors for synthesizing the lithium transition metal phosphate cathode material, wherein at least a first precursor of the group comprises a solid phase having a first density greater than 1 gram (g)/cubic centimeter (cc), and at least a second precursor of the group comprises a liquid phase having a second density, wherein the second density is less than the first density;
providing one or more carbon precursors in a fluid state, the one or more carbon precursors configured to form a solid organogel in the presence of a gelation initiator, the solid organogel configured to form a conductive carbon matrix upon pyrolysis;
mixing the group of precursors with the one or more carbon precursors to form a precursor mixture;
adding the gelation initiator to the precursor mixture;
allowing the one or more carbon precursor to undergo gelation to form a solid organogel; and
pyrolyzing the solid organogel to form the lithium transition metal phosphate cathode material within the conductive carbon matrix.

34. The method of claim 33, wherein the solid organogel forms within 5 seconds to 15 minutes after addition of the gelation initiator.

35. The method of claim 33, wherein the solid organogel comprises a porous network of interconnected solid phase polymer structures.

36. The method of claim 35, wherein the porous network maintains contact between the first precursor of the group and the second precursor of the group.

37. The method of claim 36, wherein the contact is maintained to a temperature of at least about 300° C.

38. The method of claim 33, wherein:
the first precursor comprises iron;
the second precursor comprises a lithium source and phosphoric acid; and
the lithium transition metal phosphate cathode material is lithium iron phosphate.

39. The method of claim 38, wherein the iron is present in the form of an iron (II) salt, an iron (III) salt, iron (II) oxide (FeO), iron (III) oxide (Fe₂O₃), a mixed iron oxide (Fe₃O₄), or a combination thereof.

40. The method of claim 33, wherein the solid organogel comprises a phloroglucinol-furfural polymer or a resorcinol-furfural polymer, the one or more carbon precursors are phloroglucinol or resorcinol and furfural, and the gelation initiator is an amine base or an acid.

41. The method of claim 33, wherein the solid organogel comprises a polyurethane polymer, the one or more carbon precursors comprise a polyol and an isocyanate, and the gelation initiator comprises an alkylamine.

42. The method of claim 33, wherein the organogel comprises a polyamic acid polymer and the gelation initiator comprises acetic anhydride, acetic acid, or a combination thereof.

43. The method of claim 33, wherein the group of precursors includes a precursor having microwave susceptibility and the pyrolyzing is performed by applying microwave radiation.

44. The method of claim 43, wherein the precursor having microwave susceptibility comprises one or more of carbon, magnetite, and maghemite.

45. The method of claim 44, comprising nanoparticles of one or more of magnetite and maghemite having a particle size of from 20 nm to 100 nm.

46. The method of claim 33, wherein:
the first precursor comprises manganese, vanadium, or both;
the second precursor comprises a lithium source and phosphoric acid; and
the lithium transition metal phosphate cathode material is lithium manganese phosphate or lithium vanadium phosphate.

47. The method of claim 33, further comprising drying the lithium transition metal phosphate cathode material by applying microwave radiation.

48. The method of claim 33, wherein the solid phase having the first density greater than 1 gram comprises a ferromagnetic iron compound, a ferrimagnetic iron compound, or both.

49. The method of claim 48, wherein the ferromagnetic iron compound, the ferrimagnetic iron compound, or both are synthesized by a method comprising:
oxidizing an iron-containing anode in an electrochemical cell with a porous carbon substrate, an oxygen cathode, and an electrolyte in contact with both the iron-containing anode and the porous carbon substrate; wherein
the oxidizing produces particles of the ferromagnetic iron compound, the ferrimagnetic iron compound, or both, having a particle size of from 20 nm to 100 nm.

50. The method of claim 49, further comprising removing the particles by magnetic filtration.

51. The method of claim 49, further comprising drying the particles by applying microwave radiation.

52. The method of claim 49, wherein operation of the electrochemical cell and formation of the ferromagnetic iron compound, the ferrimagnetic iron compound, or both is at a temperature between 15° C. and 35° C.

53. A composition comprising a nanoparticle comprising olivine lithium iron phosphate and integral with a conductive carbon matrix, the conductive carbon matrix comprising a carbonized organogel polymer matrix, wherein the nanoparticle has a particle size from 20 nm to 1000 nm and a nitrogen sorption BET surface area from 10 meters² (m²)/gram (g) to 65 m²/g, wherein the particle size is a diameter or one or more of a width, length, and/or depth.
